(19) United States
(12) Patent Application Publication
(10) Pub. No.: US 2015/0314245 A1
(43) Pub. Date: Nov. 5, 2015

(54) COMPOSITE SEPARATION MEMBRANE

(71) Applicant: TOYOBO CO., LTD., Osaka-shi, Osaka (JP)

(72) Inventors: Takahito Nakao, Otsu-shi (JP); Takashi Ohkame, Otsu-shi (JP); Ryouhei Yamane, Ohtsu-shi (JP); Seiji Watanuki, Otsu-shi (JP); Tooru Kitagawa, Otsu-shi (JP)

(73) Assignee: TOYOBO CO., LTD., Osaka-shi, Osaka (JP)

(21) Appl. No.: 14/647,266

(22) PCT Filed: Dec. 11, 2013
(86) PCT No.: PCT/JP2013/083166

§ 371 Date: May 26, 2015

(30) Foreign Application Priority Data
Dec. 11, 2012 (JP) 2012-270100

(51) Int. Cl. B01D 71/76; B01D 71/68; B01D 71/58; B01D 69/12

(52) U.S. Cl. CPC B01D 71/76; B01D 69/12; B01D 71/68; B01D 71/58; B01D 2325/20; B01D 2325/30

(57) ABSTRACT

The present invention provides a composite separation membrane having a separation layer formed of sulfonated polyarylene ether (SPAE) copolymer on a surface of a porous support membrane wherein both high separation property and high water permeation property are achieved. A composite separation membrane wherein a surface of a porous support membrane containing polyphenylene ether is coated with a thin film of a sulfonated polyarylene ether copolymer constituted from a repeating structure of a hydrophobic segment and a hydrophilic segment, characterized in that when proton nuclear magnetic resonance spectrum is measured at −10° C., chemical shift of a spectral peak top derived from water contained in the membrane satisfies from 4.15 ppm to less than 5.00 ppm.

### TECHNICAL FIELD OF THE INVENTION

The present invention relates to a long-life composite separation membrane having an excellent separation property and water permeation property as a liquid treating membrane, and having excellent resistance to chlorine and resistance to alkali solutions. In particular, it also relates to a composite separation membrane suitable for nanofiltration.

### BACKGROUND ART

A nanofiltration membrane means a membrane having a pore size of about 2 nanometers or less and being used for removal of hardness components such as divalent ions, low-molecular compounds, etc. In a membrane separation process, etc., divalent ion such as magnesium ion or calcium ion easily forms a hardly soluble salt called a scale, which leads to a problem of reducing the efficiency of the process. Therefore, it is very important in view of an increase in the efficiency of a process to remove divalent ion using a nanofiltration membrane in the pretreatment process.

As mentioned above, in the nanofiltration membrane, its pore size is in a nanometer order whereby its filtration resistance is apt to become large while its water flux is apt to become small. Therefore, as a nanofiltration membrane, there has been preferably used a structure of composite separation membrane wherein thin film of a separation layer having a separation function is formed as thin as possible without deficiency on a surface of a porous support membrane being excellent in mechanical strength and water permeability whereby both high water permeability and separation ability are achieved.

In a nanofiltration membrane, hardly soluble solutes and polymers, colloid, microfine solids, etc. contained in the feed solution are attached on the membrane during the operation, which leads to a phenomenon called fouling (a decrease in a permeation flux). In order to recover from the fouling, cleaning of a membrane surface is carried out periodically but the degree of recovery is greatly dependent upon types of the fouling substances and of the chemicals used for the cleaning. Therefore, with regard to a material constituting the separation layer of a nanofiltration membrane, there has been a demand in view of cleaning property and stability for a long-term operation that the material is excellent in the chemical durability or, particularly, in the resistance to chlorine and to alkali solution.

As to the structure of the conventional composite separation membranes, there is a structure wherein thin film of cross-linked aromatic polyamide is formed on a surface of a porous support membrane by means of an interfacial polymerization method. For example, in Patent Document 1, there is disclosed a composite product in a sheet form wherein thin film of cross-linked polyamide is formed on a surface of a porous support membrane by interfacial polymerization method.

In Patent Document 2, there is disclosed a hollow fiber composite separation membrane wherein thin film of cross-linked polyamide is formed on a surface of a porous support membrane in a hollow fiber form by interfacial polymerization method.

In Patent Document 3, there is also disclosed an art for forming a hollow fiber composite separation membrane wherein thin film of cross-linked polyamide is formed on a surface of a porous support membrane in a hollow fiber form by interfacial polymerization method. In said art, a step of impregnating a fluorine solution is added to a step of compositing by interfacial polymerization method so as to form a hollow fiber composite separation membrane having more uniform separation layer.

However, although the polyamide-type composite separation membrane as mentioned in Patent Document 1 are excellent in their salt rejection property and water permeation property, their resistance to chlorine is low whereby it is impossible to treat water containing sodium hypochlorite and it is also impossible to be washed with chlorine. Therefore, it is necessary to supply a dechlorinated solution to a membrane desalination unit and then to add sodium hypochlorite again to the resulting permeate, which leads to a problem that a membrane treatment process is complicated and the cost therefor is high.

In Patent Documents 2 and 3, there is also a disadvantage that resistance to chlorine is low because a polyamide-type material forms a separation layer of a composite separation membrane. Moreover, there is also a problem that a process wherein the structure formation is conducted by an interfacial polymerization method in a step of manufacturing a composite separation membrane of a hollow fiber type is complicated compared with a flat sheet membrane or a sheet-shaped product.

As a material for avoiding the above disadvantages, the Patent Document 4 discloses a separation membrane using a polymer having a sulfonated polyarylene ether (SPAE) structure being excellent in the resistance to chlorine and to alkali solutions. Since SPAE has a sulfonic group, its hydrophilic property is very high. When a nanofiltration membrane is prepared only from SPAE, its resistance to pressure becomes very low due to a decrease in strength caused by high water uptake. Accordingly, development thereof has been in progress as a composite separation membrane having a separation layer and a porous support membrane bearing the resistance to pressure.

However, as pointed out in Non-Patent Document 1 for example, since the chemical structure of SPAE is similar to one of polysulfone or polyether sulfone which is a material for common porous support membranes, most of solvents which can dissolve SPAE also can dissolve polysulfone or polyether sulfone. When the solvent as such is used as a coating solution and applied on a porous support membrane, there is resulted a problem that the porous support membrane is dissolved or significantly swollen whereby no composite separation membrane can be prepared.

Accordingly, it is inevitable to select a limitative solvent (lower carboxylic acid such as formic acid, alcohol, alkylene diol or triol, or alkylene glycol alkyl ether) which does not invade a porous support membrane formed of polysulfone or polyether sulfone. However, such a solvent also tends to become low solubility to SPAE. Particularly, as for the SPAE which has rigid structure, there are few solvents which can dissolve it. When a composite separation membrane is prepared using a solvent having insufficient solubility to SPAE, there is a problem that the separation property tends to become insufficient.

### PRIOR ART DOCUMENTS

### Patent Documents

Patent Document 1: Japanese Patent Application Laid-Open (JP-A) No. 147106/80
Patent Document 2: Japanese Patent Application Laid-Open (JP-A) No. 95105/87
Patent Document 3: Japanese Patent No. 3250644
Patent Document 4: Japanese Patent Application Laid-Open (JP-A) No. 248409/88

### Non-Patent Documents

Non-Patent Document 1: Chang Hyun Lee et al., Journal of Membrane Science, 389 (2012), 363-371, “Disulfonated poly(arylene ether sulfone) random copolymer thin film composite membrane fabricated using a benign solvent for reverse osmosis applications”

### DISCLOSURE OF THE INVENTION

### Problem that the Invention is to Solve

The present invention has been done for overcoming the above-mentioned conventional technical problem and an object of the present invention is to provide a composite separation membrane having a separation layer formed of SPAE on a surface of a porous support membrane wherein both high separation property and high water permeation property are achieved.

### Means for Solving the Problem

For a composite separation membrane formed of a combination of polymer which constitutes the porous support membrane with SPAE which constitutes a separation layer, the present inventors have investigated the solubility of each polymer in a solvent, the compositing process and the property as a composite separation membrane. Polysulfone (PSU) or polyether sulfone (PES) shows a good solubility in N-methyl-2-pyrrolidone (NMP), N,N-dimethylacetamide (DMAc), dimethyl sulfoxide (DMSO), N,N-dimethylformamide (DMF), γ-butyrolactone (GBL) and a solvent containing at least one of them (hereinafter, the above is referred to as “solvent group 1”) among aprotic polar solvents. Those solvents have excellent solubility property, exhibit a relatively low environmental load, show high safety to human body.

Accordingly, they are preferred as solvents for preparing a porous support membrane. On the other hand, SPAE which constitutes a separation layer also shows a good solubility in the solvent group 1. Accordingly, it has been impossible to use the solvent group 1 as amain component of a coating solution when a composite membrane is prepared by a coating method. Moreover, although polyvinylidene fluoride (PVDF) and polyether imide (PEI) can be exemplified as other engineering polymer which is commonly used for a porous support membrane, those polymers are also soluble in the solvent group 1 as same as in the case of the above polysulfone and polyether sulfone whereby there is also the same problem therein.

Therefore, studies have been conducted for a solvent which dissolves SPAE of a separation layer but does not dissolve a polymer of a porous support layer. However, there are not so many choices. To be more specific, apart of protonic polar solvent such as lower carboxylic acid (e.g. formic acid), alcohol, alkylene diol or triol and alkylene glycol alkyl ether (hereinafter, they will be referred to as a solvent group 2) will be exemplified.

However, the solubility of SPAE in the above solvent group 2 is not always good. In addition, with regard to the solvents having a relatively good solubility for SPAE in the solvent group 2, their affinity to a porous support membrane tends to become high and, even if they do not dissolve the porous support membrane, they significantly swell it resulting in a decrease of its mechanical strength. Even if an improvement is done such as that an appropriate amount of the solvent group 1 is added in order to enhance the solubility of SPAE in the solvent group 2, it results in a significant swelling of the porous support membrane and is not preferred. When a compositing process is conducted by a coating method using a solvent exhibiting poor solubility, there is a problem that separation property of a composite membrane becomes insufficient while, when a solvent exhibiting good solubility is used, careful attention is needed so as not to excessively swell the porous support membrane (An excessive swelling results in the deficiency and breakage of the composite separation membrane.). For example, it is necessary that the drying temperature after the coating process is made low (for example, at about 100° C. or lower) and, as a result, there is a problem that no dense separation layer is formed and no sufficient separation property is achieved. Moreover, although formic acid in the solvent group 2 exhibits relatively good solubility for SPAE, it is not preferred because it is highly toxic and has corrosive property.

In addition, in SPAE having a chemical structure suitable for the use as composite separation membrane, its solubility in a solvent is further limited. Recently, in view of stable achievement of higher ion separation property, SPAE which is subjected to molecular design by means of a direct copolymerization has been developed. To be more specific, SPAE of a chemical structure having more rigid molecular structure and stronger cohesive force of a hydrophobic segment is preferred since it achieves better mechanical property, less swelling and higher ion separation property.

However, when such a desirable chemical structure of SPAE is aimed, glass transition temperature of a polymer becomes higher whereby its solubility in a solvent lowers. For example, SPAE having a repeating structure constituted from a repeating unit of a hydrophobic segment represented by the following formula (I) and a repeating unit of a hydrophilic segment represented by the following formula (II) exhibits an excellent mechanical property due to a rigid molecular skeleton and a high cohesive force of the hydrophobic segment (I) and can form a separation layer exhibiting low swelling. Accordingly, said SPAE is suitable to be used for nanofiltration membrane. However, there is a problem that, although said SPAE is soluble in a solvent group 1, it is almost insoluble in a solvent group 2.

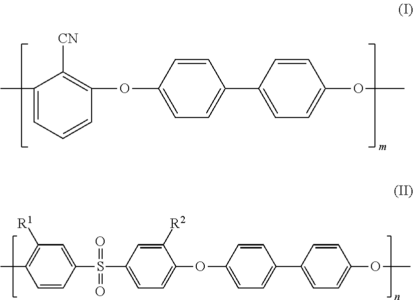

wherein m and n each represents a natural number of 1 or more;

R¹ and R² each represents —SO₃M or —SO₃H, wherein M represents a metal element; and

a sulfonation rate in terms of a percent rate of repeating number of the formula (II) in the sulfonated polyarylene ether copolymer to total of repeating number of the formula (I) and repeating number of the formula (II) in the sulfonated polyarylene ether copolymer is more than 10% and less than 70%.

Thus, when a composite separation membrane is to be prepared using SPAE which has an excellent separation property but has a low solubility in a solvent, it is not possible to use the solvent group 2 as a coating solvent whereby the solvent group 1 having a high solubility shall have to be used. For such a purpose, a porous support membrane which is insoluble in the solvent group 1 is inevitable whereby the above-mentioned known porous support membrane cannot be used.

Under such circumstances, the present inventors have tried to find a polymer which is insoluble in the solvent group 1 and is suitable for a porous support membrane of a composite separation membrane. They have repeatedly investigated by preparing a composite separation membrane wherein the above-mentioned SPAE is coated on the polymer. It is preferred that a porous support membrane can support the thin separation layer under the pressure upon a separation operation (0.1 to 2.0 MPa) and can be stably used for a long period. It is an inevitable condition to use a polymer having excellent mechanical strength and durability to chemicals. Further, it is preferred that the porous support membrane has appropriate solubility in a solvent and that a membrane having a pore size within an extent of an ultrafiltration membrane being suitable as a porous support membrane of a composite separation membrane can be easily prepared by means of a known wet or dry-wet phase inversion method for membrane preparation. In order to achieve a high mechanical strength, a polymer having a high glass transition temperature is preferred. Further, in order to achieve an appropriate solubility in a solvent, an amorphous polymer is preferred. Thus, to be more specific, a porous support membrane using an amorphous aromatic polymer is preferred.

Table 1 shows solubility, etc. of known typical polymers in aprotic polar solvents.

TABLE 1

| | | | Glass | | | | | | |
|---|---|---|---|---|---|---|---|---|---|
| | | | transition | Melting | | | | | |
| | Kind of polymer | | temp. T_{g} | point Tₘ | Solubility in aprotic polar solvent (solvent group 1) | | | | |
| | | Abbreviation | ° C. | ° C. | NMP | DMAc | DMF | GBL | DMSO |
| Amorphous | polyether sulfone | PES | 225 | — | soluble | soluble | soluble | soluble | soluble |
| | polysulfone | PSU | 190 | — | soluble | soluble | soluble | soluble | soluble |
| | polyether imide | PEI | 218 | — | soluble | soluble | soluble | soluble | soluble |
| | polyamide imide | PAI | 275 | — | soluble | soluble | soluble | soluble | soluble |
| | polyphenylene ether | PPE | 210 | — | insoluble | insoluble | insoluble | insoluble | insoluble |
| | | | | | (soluble only | (soluble only | (soluble only | | |
| | | | | | at high | at high | at high | | |
| | | | | | temperature) | temperature) | temperature) | | |
| Crystalline | polyvinylidene fluoride | PVDF | −35 | 168-180 | soluble | soluble | soluble | soluble | soluble |
| | polyphenylene sulfide | PPS | 93 | 280 | insoluble | insoluble | insoluble | insoluble | insoluble |
| | polyether ether ketone | PEEK | 145 | 334 | insoluble | insoluble | insoluble | insoluble | insoluble |

It has been known that, generally, solubility of crystalline and semicrystalline polymers having high crystallization degree in a solvent is poor. For example, polyphenylene sulfide (PPS), polyether ether ketone (PEEK) or the like has been known as a crystalline polymer having excellent mechanical strength and durability to chemicals. Such a one is inherently insoluble in most of known solvents except inorganic acids. Accordingly, although it can be subjected to a melt molding, it is not suitable for a wet or dry-wet phase inversion method for membrane preparation whereby it is not easy to prepare a porous support membrane suitable for a composite membrane. As to an amorphous aromatic polymer, although polyether imide (PEI), polysulfone (PSU) and polyether sulfone (PES) have appropriate solubility in a solvent, they are soluble in the solvent group 1. Although polyvinylidene fluoride (PVDF) is a crystalline polymer, it is a non-aromatic polymer and exhibits low glass transition temperature and, although it has an appropriate solubility in a solvent, it is still soluble in the solvent group 1.

Among the known amorphous aromatic polymers, the present inventors have paid their attention to a special solubility in a solvent shown by polyphenylene ether (PPE). It has been found that polyphenylene ether is not soluble in the solvent group 1 or exhibits a limited solubility therein and that polyphenylene ether is a suitable polymer as a porous support membrane for achieving the object of the present invention.

To be more specific, polyphenylene ether is absolutely insoluble in dimethyl sulfoxide (DMSO) or γ-butyrolactone (GBL) among the solvent group 1 of aprotic polar solvents. On the other hand, although polyphenylene ether is insoluble in N-methyl-2-pyrrolidone (NMP), dimethylacetamide (DMAc) and N,N-dimethylformamide (DMF) at least at ordinary room temperature, it is soluble therein at the high temperature region as will be mentioned later. Due to this fact, a porous support membrane can be easily prepared from polyphenylene ether. Therefore, when a porous support membrane formed of polyphenylene ether is used, a porous support membrane is not invaded even if a coating solution prepared by dissolving SPAE in the solvent group 1 is applied thereon. Further, it has been found that, when a combination of suitable solvents from the solvent group 1 is selected, a polyphenylene ether porous support membrane is not excessively swollen by the solvent and accordingly that, even if the solvent is quickly dried at relatively high temperature in a drying step after coating, breakage of a membrane and decrease in the property hardly happen. Such a finding is a big advantage in a method for manufacturing a composite separation membrane. It is now possible to stably and easily form a dense separation layer of SPAE having an excellent separation ability provided that the solvent is quickly dried at high temperature (100° C. or higher) even in the case of the solvent group 1 having relatively high boiling point (150 to 210° C.). It has been also found that, since the solubility of SPAE in the solvent group 1 is good whereby stability of a solution can be maintained even when a desired non-solvent is added to a considerable extent (such as 50% by weight or more) and accordingly that vapor pressure and surface tension of a coating solution can be controlled to a desired condition and a composite separation membrane suitable to be used for nanofiltration can be prepared.

Further, for achieving both high separation property and high water permeation property in the above composite separation membrane, the present inventors have paid their attention to the state of water existing in the membrane. It has been known that, generally, bound state and mobility of the water contained in a membrane are important for deciding the properties of the membrane. With regard to bound state and mobility of water, much information is available from a nuclear magnetic resonance apparatus for the measurement of solutions (solution-state NMR). Particularly, the chemical shift upon measurement of proton of water molecules in a membrane is in a correlation to the bound state of water. Depending upon the degree of strength of the interaction between polymer chain and water in the membrane, electron density of proton of water molecule varies. When electron density of proton is high, magnetic shielding effect to the applied magnetic field is big whereby the effective magnetic field acting on proton becomes small and chemical shift of proton of water molecule in the membrane moves to a high magnetic filed side. On the contrary, when electron density of proton is low, magnetic shielding effect to the applied magnetic field is small whereby the effective magnetic filed acting on proton becomes large and chemical shift of proton of water molecule in the membrane moves to a low magnetic field side.

Incidentally, according to the known document (Kim, Y. S. et al., Journal of Membrane Science, 243 (2012) 317-326, “Sulfonated poly(arylene ether sulfone) copolymer proton exchange membranes: composition and morphology effects on the methanol permeability”), the state of water contained in a membrane is classified into three groups which are free water, bound water and non-freezing water. Free water is not affected by polymer chain constituting the membrane and phase transition enthalpy and temperature have the same property as those of bulk water. Bound water shows an interaction with polymer chain constituting the membrane. Accordingly, bound water exhibits such a property that the phase transition temperature is different from that of bulk water but is 0° C. or lower. Non-freezing water shows strong interaction with polymer chain constituting the membrane. Accordingly, non-freezing water exhibits such a property that no phase transition happens. Among them, free water having the same property as that of bulk water can freely move in a membrane whereby, although it contributes in water permeation, it is also a cause of a medium inducing the permeation of salt. Thus, it is in a trade-off relation that, when permeation of salt is suppressed, water permeation property lowers. This has been pointed out in the known document (Geoffrey, M. G. et al., Journal of Membrane Science, 369 (2011) 130-138, “Water permeability and water/salt selectivity tradeoff in polymers for desalination”). The trade-off relation can be said only for SPAE which is a separation layer polymer. A porous support membrane containing polyphenylene ether is a membrane having the pores in a degree of ultrafiltration membrane. Accordingly, with regard to the porous support membrane containing polyphenylene ether, only free water exists.

When water in a membrane is analyzed by means of a solution-state NMR, proton exchange among water is quickly conducted whereby electron density of proton of water molecule existing in the membrane is almost averaged and, accordingly, there is obtained a peak showing an average state of water in the membrane. In a composite separation membrane, porous support membrane occupies most of the membrane in terms of volume fraction as compared with an SPAE separation layer whereby affection by free water existing in the porous support membrane is great. As a result, peaks of water in the composite separation membranes having different properties appear in the similar positions in any of the membranes. Under such circumstances, the present inventors have come to an idea to lower the measuring temperature in a solution-state NMR measurement. The solution-state NMR used here is an NMR for measuring a solution and, when water in the membrane is frozen, no peak appears. In a common solution-state NMR measurement, it is usual to be measured at ordinary room temperature. The present inventors have planned to freeze the free water by making the measuring temperature −10° C. and to obtain a NMR spectra which reflects the state of only bound water and non-freezing water existing in the SPAE separation layer. Thus, in a solution-state NMR measurement at −10° C., an average analysis result of water except free water existing in the membrane is obtained while, when there are many components showing stronger binding, chemical shifts move to a higher magnetic field side.

Thus, the present invention has the following constitutions (1) to (6).

(1) A composite separation membrane comprising a porous support membrane and a thin film of a sulfonated polyarylene ether copolymer, characterized in that

(a) the porous support membrane is mainly formed of polyphenylene ether and

(b) when proton nuclear magnetic resonance spectrum is measured at −10° C. using the composite separation membrane being moistened under a condition of constant temperature and constant humidity, a peak top position derived from water contained in the membrane is from 4.15 ppm to less than 5.00 ppm provided that a peak top position of tetramethylsilane which is an internal standard substance is taken as 0 ppm.

(2) The composite separation membrane according to (1), wherein said sulfonated polyarylene ether copolymer is constituted from a repeating structure of a hydrophobic segment represented by the following formula (IV) and a hydrophilic segment represented by the following formula (V):

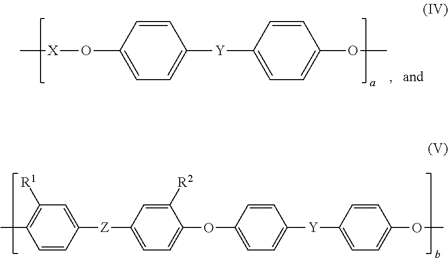

wherein X is either the following formula (VIII) or (IX):

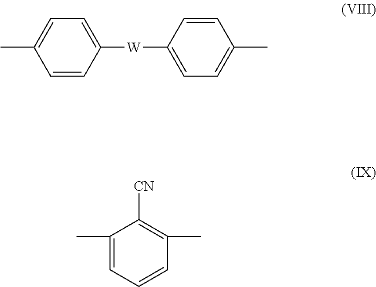

wherein Y is a single bond or any of the following formulae (X)-(XIII):

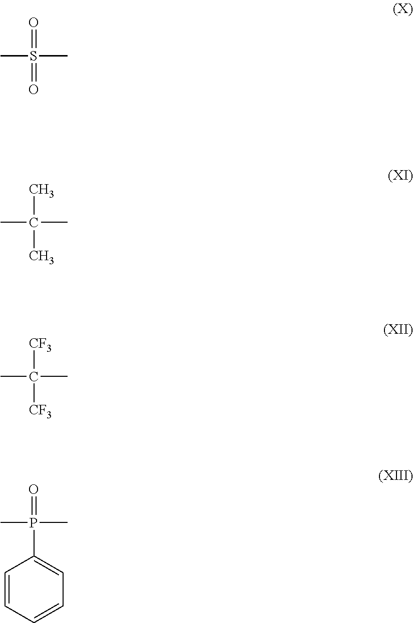

wherein Z is a single bond or any of the following formulae (X), (XIV) and (XIII):

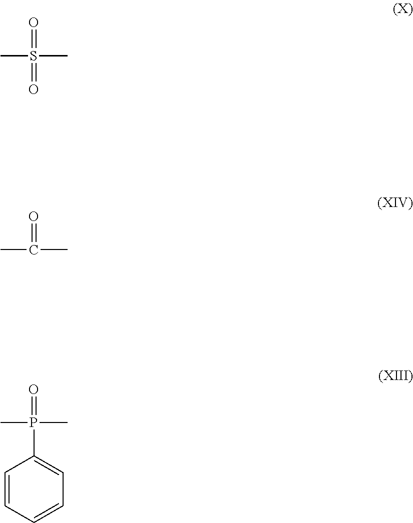

wherein W is a single bond or any of the following formulae (X), (XIV) and (XIII):

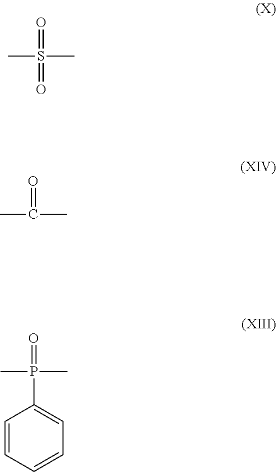

wherein Y and W are not selected as the same thing;

wherein a and b each represents a natural number of 1 or more;

wherein R¹ and R² each represents —SO₃M or —SO₃H, wherein M represents a metal element; and

wherein a sulfonation rate in terms of a percent rate of repeating number of the formula (V) in the sulfonated polyarylene ether copolymer to total of repeating number of the formula (IV) and repeating number of the formula (V) in the sulfonatedpolyarylene ether copolymer is more than 10% and less than 70%.

(3) The composite separation membrane according to (1) or (2), wherein said sulfonatedpolyarylene ether copolymer is constituted from a repeating structure of a hydrophobic segment represented by the following formula (I) and a hydrophilic segment represented by the following formula (II):

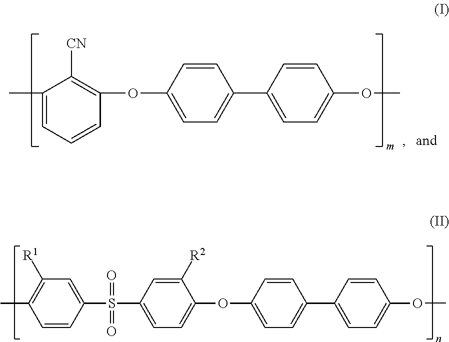

wherein m and n each represents a natural number of 1 or more;

wherein R¹ and R² each represents —SO₃M or —SO₃H, wherein M represents a metal element; and

wherein a sulfonation rate in terms of a percent rate of repeating number of the formula (II) in the sulfonated polyarylene ether copolymer to total of repeating number of the formula (I) and repeating number of the formula (II) in the sulfonated polyarylene ether copolymer is more than 10% and less than 70%.

(4) The composite separation membrane according to any of (1) to (3), wherein thickness of the thin film of the sulfonated polyarylene ether copolymer is from 50 nm to 500 nm.

(5) The composite separation membrane according to any of (1) to (4), wherein the composite separation membrane is for a nanofiltration membrane.

(6) The composite separation membrane according to any of (1) to (5), wherein the composite separation membrane is a hollow fiber membrane.

### Advantages of the Invention

In the composite separation membrane of the present invention, a solvent which does not swell a porous support membrane and has a good solubility for SPAE is used in forming a separation layer formed of a specific SPAE on a surface of the porous support membrane containing polyphenylene ether and, moreover, a bound state of water in the composite separation membrane formed by applying SPAE onto a surface of the porous support membrane of polyphenylene ether is controlled. As a result, a salt rejection property and a water permeation property being demanded for the nanofiltration can be achieved in high levels.

### BRIEF DESCRIPTION OF THE DRAWINGS

FIG. 1 shows result of NMR measurement of water bound in a membrane.

FIG. 2 shows relation among drying temperature, content of sulfonic group and membrane property.

FIG. 3 shows a schematic drawing (flat sheet membrane) according to the present invention.

FIG. 4 shows a schematic drawing (hollow fiber membrane) according to the present invention.

FIG. 5 is an SEM (scanning electron microscope) image of the cross section of the composite separation membrane of Example 1.

FIG. 6 is an enlarged SEM image of the outer layer part of the cross section of the composite separation membrane of Example 1.

FIG. 7 is an enlarged SEM image of the surface of the composite separation membrane of Example 1.

### DETAILED DESCRIPTION OF THE INVENTION

The composite separation membrane of the present invention is characterized in that a separation layer exists on the surface of a porous support membrane, that the porous surface membrane contains polyphenylene ether and that the separation layer is formed of a sulfonated polyarylene ether copolymer constituted from a specific repeating structure.

The composite separation membrane of the present invention is suitable as a liquid treating membrane or particularly as a nanofiltration membrane. A nanofiltration membrane is a separation membrane having a separation layer having pore size of several nm or less and is a liquid treating membrane which can partially remove low-molecular organic molecules, univalent ions and multivalent ions. To be more specific, it is used in a water purifying step for removing organic solvents and agricultural chemicals from underground water and river water; a separation of a mixture of salts, amino acids and proteins in the field of food technology; a removal of salts from whey in dairy industry; a process for removing scale components such as calcium ion and magnesium ion which is provided in a previous stage for a process for making saline water into fresh water; etc. Pressure during a separation operation of a nanofiltration membrane is as low as from 0.1 MPa to 2.0 MPa. With regard to salt rejection property and water permeation property of a separation membrane demanded for a nanofiltration membrane, a salt rejection when NaCl is used as a common case is preferred to be from 20% to less than 93% and a salt rejection when a divalent ion such as MgSO₄ is used is preferred to be 70% or more, more preferred to be 90% or more, and further preferred to be 95% or more.

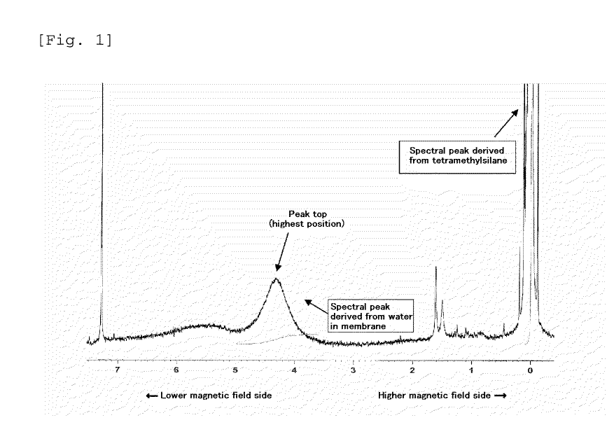

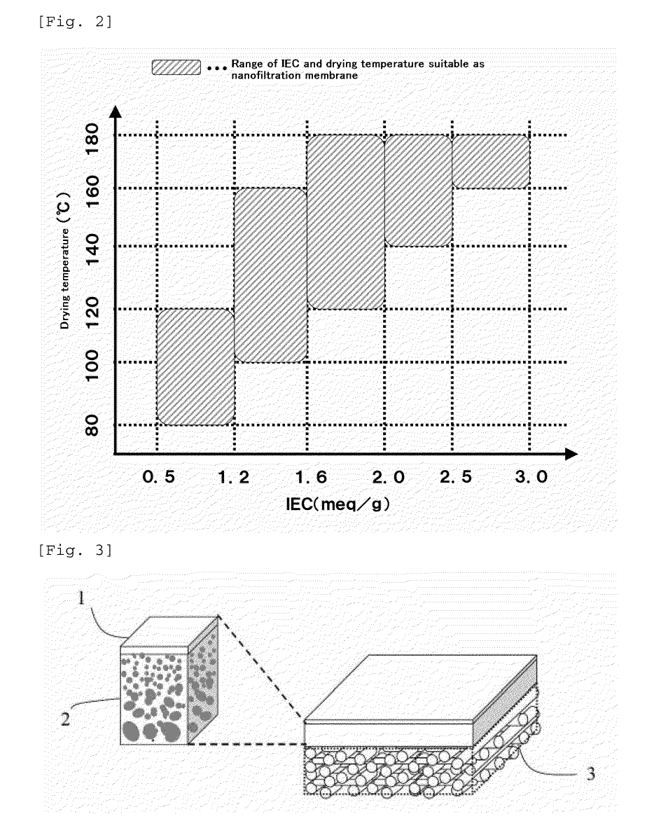

The composite separation membrane of the present invention is such a membrane wherein a thin film formed of a polymer having a separation property for a size being near that of target fractionating substance is formed on the surface of a porous support membrane formed of a hydrophobic polymer having sufficiently larger pores than the size of the target substance to be fractionated (diameter: about 10 nm to about several hundred nm). The composite separation membrane of the present invention is constituted from at least two kinds of polymers. It is possible to clearly discriminate each of the polymers constituting the separation layer and the porous support membrane. In the case of a flat sheet membrane as shown by FIG. 1, a porous support membrane 2 is placed on nonwoven fabric 3 such as polyester and a thin film of a separation layer 1 is further formed on the surface of the porous support membrane 2. In the case of a hollow fiber membrane as shown by FIG. 2, a thin film of a separation layer 1 is formed on a surface of a porous support membrane 2 in a hollow fiber form. Here, a thin film stands for a film in the thickness of 50 nm to 500 nm. Thickness of a porous support membrane is well thicker than a thin film and is at least 5 μm.

On the other hand, as a membrane structure which is different from a composite separation membrane of the present invention, there is an asymmetric membrane. An asymmetric membrane is a membrane prepared by coagulation of a dope for membrane preparation by means of a phase separation method, and is controlled so as to make the surface layer of a membrane dense and, the inner layer side of the membrane porous. Although an asymmetric membrane may be constituted from one or more kind (s) of polymer component (s) using a polymer blending method or the like, it is basically a membrane prepared only by controlling the gradient of polymer density in the membrane and, in the separation layer and the porous support layer, the polymer component (s) is/are the same. It is general that, in a composite separation membrane, structure and thickness of the porous support membrane and structure and thickness of the separation layer can be independently controlled and, therefore, water permeation property becomes higher. Due to these reasons, the composite separation membrane is preferred as a membrane structure.

The composite separation membrane of the present invention is characterized in that, in a proton nuclear magnetic resonance (NMR) spectra wherein water molecules in the membrane are measured using the membrane in a water-containing state, a chemical shift (hereinafter, it will be referred to as “a”) of the spectral peak top derived from bound water at the measuring temperature of −10° C. satisfies the range of from 4.15 ppm to less than 5.00 ppm. A composite separation membrane wherein a porous support membrane contains polyphenylene ether and a separation layer is formed of SPAE has a sulfonic group. It is believed that the water in the membrane carries out a strong interaction particularly to this sulfonic group. Electron density of the sulfonic group is big as compared with that of bulk water. It is believed that the electron density around water molecule in the membrane forming a strong interaction is slightly more than that of bulk water. Accordingly, chemical shift of water molecule in the membrane appears in a higher magnetic field side than that of the bulk water. Method for measuring the proton NMR of water molecule in the membrane is as follows. A composite separation membrane is provided which has been previously washed with water and dried at 60° C. for 4 hours. Twenty composite separation membrane samples are prepared by cutting the above composite separation membrane into 7 cm length. A deuterated chloroform solution containing 2% by mass of tetramethylsilane as an internal standard substance for the NMR measurement is sealed into a capillary and the above-prepared 20 composite separation membrane samples are inserted into an NMR tube of 5 mm diameter and then allowed to stand for 120 hours in a thermohygrostat which is kept at 40° C. temperature and 80% relative humidity so as to make into a water-containing state. The above composite separation membrane samples in a water-containing state are subjected to a proton NMR measurement using Avance 500 manufactured by Bruker (resonance frequency: 500.13 MHz; measuring temperature: −10° C.; FT integration: 64 times; waiting time: 5 seconds). At that time, a waiting period of 60 minutes is set for the stabilization of temperature after the temperature reached −10° C.

FIG. 1 shows an example of the proton NMR spectral charts. Among the spectral peaks observed at that time, the peak appearing in the highest magnetic field side is a spectral peak derived from tetramethylsilane and this peak top is taken as 0 ppm and adopted as a standard. A peak which appears in a lower magnetic field side is a peak derived from water in the membrane. Chemical shift of the peak top of the spectral peak derived from water in the membrane is calculated. The term reading “peak top” stands for the highest position of the spectra obtained as a result of the NMR measurement.

When “a” is less than 4.15 ppm, the membrane structure becomes significantly dense as a whole and the membrane exhibits NaCl rejection ability of about 93% or more. Accordingly, the membrane is not practical as a nanofiltration membrane. On the other hand, when “a” is 5.00 ppm or more, no salt rejection ability is exhibited or the NaCl rejection ability becomes lower than 20% and MgSO₄ rejection ability becomes lower than 70%. Accordingly, the membrane is not preferred as a nanofiltration membrane.

Now the chemical interaction between the water molecule in the composite separation membrane of the present invention and the polymer chain constituting the membrane as well as the correlation to the membrane properties will be discussed. As a method for preparing only such water which is contained in the SPAE copolymer thin film in the composite separation membrane, there is used a method for preparing a sample utilizing a thermohygrostat as mentioned above. According to this method, it is possible to remove a solution particularly being contained in polyphenylene ether by means of washing with water and drying and, even when the membrane is allowed to stand in a thermohygrostat thereafter, water is not contained in the hydrophobic polyphenylene ether but is contained only in SPAE. As a result of utilizing the above method, it is now possible that only water which determines the membrane properties is retained in a membrane.

According to the study of the present inventors, membrane properties are determined by various factors such as content of sulfonic group in SPAE; vapor pressure of a coating solvent for SPAE; solubility of SPAE in a selected coating solvent; drying temperature in a step of making into a composite membrane by coating SPAE; and thickness of the coated SPAE. The thickness of the coated SPAE in the composite separation membrane is preferred to be 50 nm to 500 nm and more preferred to be 100 nm to 300 nm. When the SPAE thickness is less than 50 nm, deficiency is apt to be resulted while, when it is more than 500 nm, resistance of SPAE separation layer to the permeation becomes high and no sufficient water permeation property as a nanofiltration membrane is achieved. It has been found that, when a solvent of the solvent group 1 is used as a coating solvent for SPAE and when thickness of the SPAE separation layer is made 100 nm to 300 nm, variations in the membrane properties due to the used solvent and to the thickness of separation layer are small and that the content of sulfonic group in SPAE and the drying temperature in a step of making into a composite membrane by coating SPAE are strongly correlated to the above “a”. FIG. 2 shows the content of sulfonic group in SPAE, the drying temperature in a step of making into a composite membrane by coating SPAE and the range showing the good membrane properties as a nanofiltration membrane. When the content of sulfonic group in SPAE is from 0.5 meq/g to less than 1.2 meq/g, “a” is within a range of 4.15 ppm≦a<5.00 ppm in a temperature range of from 80° C. to lower than 120° C. When the content of sulfonic group in SPAE is from 1.2 meq/g to less than 1.6 meq/g, “a” is within a range of 4.15 ppm≦a<5.00 ppm in a temperature range of from 90° C. to lower than 140° C. When the content of sulfonic group in SPAE is from 1.6 meq/g to less than 2.0 meq/g, “a” is within a range of 4.15 ppm≦a<5.00 ppm in a temperature range of from 100° C. to lower than 160° C. When the content of sulfonic group in SPAE is from 2.0 meq/g to less than 2.5 meq/g, “a” is within a range of 4.15 ppm≦a<5.00 ppm in a temperature range of from 110° C. to lower than 180° C. When the content of sulfonic group in SPAE is from 2.5 meq/g to less than 3.0 meq/g, “a” is within a range of 4.15 ppm≦a<5.00 ppm in a temperature range of from 120° C. to lower than 180° C. When the content of sulfonic group in SPAE is less than 0.5 meq/g, the amount of water in a membrane is significantly small whereby confirmation of a peak in the proton NMR is not possible or analysis is difficult because of too small peak. In a composite separation membrane prepared under such a condition, permeation of water cannot be confirmed or water permeation property is significantly low whereby the membrane is not practical as a nanofiltration membrane. When the content of sulfonic group in SPAE is 3.0 meq/g or more, “a” is 5.00 ppm or more regardless of the drying temperature. Although a composite separation membrane prepared under such a condition exhibits a sufficiently higher water permeation property, it does not exhibit an NaCl rejection property or exhibit a salt rejection property of as low as less than 20% whereby the membrane is not practical as a nanofiltration membrane and is not preferred.

Although the detailed mechanism is not clear, the present inventors have found that, as mentioned above, the content of sulfonic group in SPAE used for a separation layer and the drying temperature in a step of making into a composite membrane by coating SPAE are correlated to the membrane properties. In a polymer having a sulfonic group such as SPAE, ion channel being constituted from sulfonic group plays a role on salt rejection and water permeation. When the content of sulfonic group in SPAE is too high, there is a tendency of formation of big ion channel being constituted from many sulfonic groups. When sulfonic group which is a hydrophilic group is contained too much, water content becomes high and, as a result, ion channel is swollen. As a result of swelling, density of sulfonic group in ion channel lowers and water contained in ion channel can bind only weakly. As a result, water molecules being diffused in the membrane when the membrane is used as a nanofiltration membrane cannot efficiently interact with sulfonic group but pass through the membrane whereby no salt rejection ability can be achieved. Since such a membrane exhibits significantly weak bound state of water in the membrane, the membrane has high “a”. On the contrary, when the content of sulfonic group in SPAE is too low, ion channel constituted from sulfonic group becomes significantly small whereby the water existing in the membrane is excessively bound by sulfonic group. The diffusing speed of the water being diffused in the membrane becomes significantly small because the water is strongly bounded by sulfonic group whereby, under the pressure used in a nanofiltration membrane, the water permeation property becomes significantly small or no water permeation property can be expressed. Since water content is significantly small in such a membrane, no peak in a proton NMR can be confirmed or, since the peak is significantly small, analysis is difficult. Even when the content of sulfonic group in SPAE is controlled to a suitable range, drying temperature for making into a composite membrane by coating SPAE is still an important factor for deciding the membrane properties. When drying temperature in making into a composite membrane by coating SPAE is too high, evaporation of a solvent for SPAE proceeds too quickly whereby a SPAE separation layer becomes significantly dense and, accordingly, the water in SPAE separation layer is too strongly bounded by sulfonic group. As a result, under the pressure used in a nanofiltration membrane, water permeation property is significantly low or no water permeation property can be expressed whereby “a” becomes low. On the contrary, when drying temperature is too low, evaporation of a solvent for SPAE becomes significantly slow whereby phase separation by water vapor in the air proceeds and, as a result, a separation layer having high water content is formed. When such a membrane is used as a nanofiltration membrane, water molecules being diffused in the membrane cannot efficiently interact with sulfonic group but pass through the membrane whereby a salt rejection property is significantly low or no salt rejection property is expressed and, as a result, “a” becomes high.

Based on the above findings, the nanofiltration membrane of the present invention is set up in such a manner that “a” satisfies the range of 4.15 ppm≦a<5.00 ppm.

Now a porous support membrane and a separation layer of the composite separation membrane of the present invention and a method for manufacturing the same will be successively illustrated in detail.

Polyphenylene ether used in a porous support membrane of the composite separation membrane of the present invention is represented by the following formula (III).

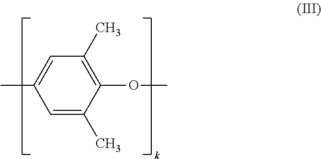

In the above formula (III), k is a natural number of 1 or more.

Number-average molecular weight of polyphenylene ether is preferred to be 5,000 to 500,000. Within such a range, it is soluble at high temperature in a part of aprotic polar solvents shown in the above-mentioned solvent group 1 and viscosity of a dope for membrane preparation becomes sufficient whereby a porous support membrane having sufficient strength can be prepared.

In view of enhancing the strength of a porous support membrane or optimizing the membrane property, the polyphenylene ether may be subjected to a polymer blending using polystyrene which has been known to be completely compatible with polyphenylene ether or using various kinds of polymers. Alternatively, a filler may be contained in polyphenylene ether. Further, in view of imparting the hydrophilicity to a porous membrane of polyphenylene ether which is a hydrophobic polymer, ionic surfactant, nonionic surfactant or a hydrophilic polymer such as polyethylene glycol or polyvinylpyrrolidone may be contained therein. However, the rate of polyphenylene ether constituting a porous support membrane is preferred to be 50% by mass or more. It is more preferred to be 80% by mass or more. When it is within the above range, a polyphenylene ether porous support membrane is not invaded by a solvent group 1 but the characteristic of polyphenylene ether which is high mechanical strength and resistance to chemicals is still maintained whereby it is advantageous in the step for manufacturing a composite separation membrane.

As to a solvent for the preparation of a porous support membrane from polyphenylene ether, N-methyl-2-pyrrolidone (NMP), N,N-dimethylacetamide (DMAc) and N,N-dimethylformamide (DMF) are preferred among the aprotic polar solvents of the solvent group 1 since they are the so-called “latent solvents” which can afford a uniform dope for membrane preparation at high temperature of, for example, about 60° C. or higher while, at the temperature of lower than the above, polyphenylene ether is insoluble therein. However, with regard to the temperature range wherein polyphenylene ether is soluble in the latent solvents, it may vary depending upon molecular weight of the polyphenylene ether, polymer concentration of the dope for membrane preparation and interaction among the separately added substance, polymer and latent solvent and, accordingly, it should be appropriately adjusted. Among the above, N-methyl-2-pyrrolidone is particularly preferred since the stability of the dope for membrane preparation is good. On the other hand, dimethyl sulfoxide, γ-butyrolactone, etc. among the solvent group 1 are the non-solvents which do not dissolve polyphenylene ether even under the temperature condition of as high as 100° C. or higher whereby they are not preferred as the solvents for membrane preparation for preparing a porous support membrane.

The “latent solvent” in the present invention is such a solvent that, in a dope for membrane preparation of a porous support membrane, there exists Flory's theta temperature inherent to the solvent (temperature by which interaction acting among the segments of polymer chain is apparently zero or, in other words, temperature wherein the second virial coefficient is zero) to the polymer which is a solute (it is polyphenylene ether in the present invention) and the theta temperature is ordinary room temperature or lower than a boiling point of the solvent. When the temperature is higher than the theta temperature, a uniform dope for membrane preparation is obtained while, when it is lower than the theta temperature, the polymer is insoluble in a solvent. Actually, the apparent theta temperature of a dope for membrane preparation in the present invention varies to some extent depending upon the polymer concentration and the solvent composition. The term “good solvent” stands for such a solvent wherein, in a dope for membrane preparation, repulsive force acting among the segments of polymer chain is more than attractive force and a uniform dope for membrane preparation can be obtained at ordinary room temperature regardless of the temperature. The term “non-solvent” stands for such a solvent wherein there exists no theta temperature or theta temperature is extremely high whereby the polymer is entirely insoluble regardless of the temperature.

As to polyphenylene ether, it has been known that, besides the above-mentioned latent solvents, there exists also good solvents in which polyphenylene ether is soluble even at ordinary room temperature and, as summarized in known literatures (for example, please refer to G. Chowdhury, B. Kruczek, T. Matsuura, Polyphenylene Oxide and Modified Polyphenylene Oxide Membranes Gas, Vapor and Liquid Separation, 2001, Springer), non-polar solvents (hereinafter, abbreviated as the solvent group 3) such as carbon tetrachloride, carbon disulfide, benzene, toluene, chlorobenzene, dichloromethane and chloroform have been known. However, unlike the above-mentioned solvent group 1, although those solvents can dissolve polyphenylene ether at ordinary room temperature, environmental load is big and harmfulness to human body is also very high whereby its industrial use as a dope for membrane preparation is not preferred.

As to a means for preparing a porous support membrane from a dope for membrane preparation wherein polyphenylene ether is dissolved in the above latent solvent, it is preferred to use a wet and a dry-wet phase inversion method for membrane preparation. A wet phase inversion method for membrane preparation is such a method wherein a dope for membrane preparation in a homogeneous solution form is immersed in a coagulation bath consisting of a non-solvent which is miscible with good solvent in the dope but polymer is insoluble therein and then a polymer is subjected to a phase separation to separate therefrom whereby a membrane structure is formed. A dry-wet phase inversion method for membrane preparation is such a method wherein, immediately before the dope is immersed in a coagulation bath, a solvent is evaporated/dried for a predetermined period from the surface of the dope to give an asymmetric structure wherein polymer density on the membrane surface layer becomes much dense. In the present invention, it is more preferred to choose a dry-wet phase inversion method for membrane preparation.

In a composite separation membrane of the present invention, although the shape of the membrane is not particularly limited, it is preferred to be a flat sheet membrane or a hollow fiber membrane. Any of the membrane as such may be prepared by a conventional method which has been known by persons skilled in the art. In the case of a flat sheet membrane for example, it can be prepared by such a manner that a dope for membrane preparation is subjected to casting on a substrate followed, if desired, by giving a drying period for a predetermined period and is then immersed in a coagulation bath. In the case of a hollow fiber membrane, it can be prepared by such a manner that a dope for membrane preparation is discharged from outer slits of spinning nozzles of a double cylindrical type so that the dope becomes in a hollow cylindrical shape while, from inner pores of nozzle inside thereof, a fluid selected from non-solvent, latent solvent, good solvent or a mixed solvent thereof, liquid which is not compatible with a solvent for membrane preparation and gas such as nitrogen or air is extruded together with the dope followed, if desired, by giving a drying period for a predetermined period and is then immersed in a coagulation bath.

Concentration of polyphenylene ether in a dope for membrane preparation is preferred to be 5% by mass to 60% by mass in such a view that mechanical strength of a support membrane is kept sufficient and, at the same time, water permeation property and surface pore size of the porous support membrane are made appropriate. It is more preferred to be 10% by mass to 50% by mass.

Temperature of the dope for membrane preparation is preferred to be 40° C. or higher. It is more preferred to be 60° C. or higher. Upper limit of the temperature is preferred to be the boiling point of the above solvent for membrane preparation or lower, more preferred to be 150° C. or lower, and further preferred to be lower than 100° C. When the temperature of the dope for membrane preparation is lower than the above range, temperature of polyphenylene ether becomes the above-mentioned theta temperature or lower and polymer is separated out whereby it is not preferred. In view of the experience of the present inventors, a solidified product of polyphenylene ether prepared when the above dope for membrane preparation is allowed to stand at theta temperature or lower is fragile whereby it is not preferred as a separation membrane. More preferred membrane structure can be obtained rather by such a means that the dope which is at the theta temperature or higher and is in a homogeneous state is immersed in a coagulation bath filled with non-solvent, leading to non-solvent-induced phase separation and membrane structure formation. On the other hand, when temperature of the dope for membrane preparation is too higher than the above range, viscosity of the dope lowers and shape forming becomes difficult whereby it is not preferred. There also happens such a problem thereby for example that, since evaporation rate of good solvent in the dope and solvent exchange rate in the coagulation bath become too high, polymer density on the membrane surface becomes too dense whereby water permeation property as a support membrane significantly lowers.

In a dry-wet phase inversion method for membrane preparation, a predetermined drying time for the solvent is given before a step wherein a dope for membrane preparation is immersed in a coagulation bath. Drying time and temperature are not particularly limited but should be adjusted in such a manner that the finally obtained asymmetric structure of a porous support membrane becomes a desired one. It is preferred that, for example, the solvent is partly dried for 0.01 to 600 second (s) at the environmental temperature of 5 to 200° C.

With regard to non-solvent for a coagulation bath used for a wet phase inversion method for membrane preparation or a dry-wet phase inversion method for membrane preparation, it is not particularly limited and, in accordance with the known membrane preparation method, it is preferred to be water, alcohol and polyhydric alcohol (such as ethylene glycol, diethylene glycol, triethylene glycol or glycerol). A mixed liquid thereof is also acceptable. In view of simplicity and economy, it is preferred that water is contained therein as a component.

Similarly, other substance may be also added to the non-solvent of the coagulation bath in accordance with the known membrane preparation method. For example, in such a view that a solvent exchange rate in a coagulation process is controlled and a membrane structure is made into a preferred one, a solvent in the solvent group 1 or, particularly, a latent solvent such as N-methyl-2-pyrrolidone or N,N-dimethylacetamide may be preferably added to a coagulation bath. In addition, polysaccharide, water-soluble polymer or the like may also be added in order to control the viscosity of a coagulation bath.

Temperature of a coagulation bath is not particularly limited but may be appropriately selected in view of controlling the pore size of a porous support membrane or in view of economy and safe operation. To be more specific, a range of from 0° C. to lower than 100° C. is preferred, and a range of from 10° C. to 80° C. is more preferred. When the temperature is lower than the above range, viscosity of a coagulation bath becomes too high whereby a de-mixing process proceeds in more retarded manner and, as a result, the membrane structure becomes dense and water permeation property of the membrane tends to lower and, accordingly, it is not preferred. When the temperature is higher than the above range, a de-mixing process proceeds more instantly and, as a result, the membrane structure becomes rough and the membrane strength tends to lower and, accordingly, it is not preferred.

With regard to the time for immersing in a coagulation bath, it is adjusted to such time that the structure of a porous support membrane is sufficiently produced due to a phase separation. In such a view that the coagulation is sufficiently advanced while steps therefor are not made uselessly long, the time is preferred to be within a range of from 0.1 to 1000 second (s). It is more preferred to be within a range of from 1 to 600 second(s).

A porous support membrane which is prepared by completing the membrane structure formation in a coagulation bath is preferred to be washed with water. There is no particular limitation for a washing method with water. A porous support membrane may be immersed in water for sufficient time or may be washed with running water for a predetermined period while being conveyed.

It is preferred that the porous support membrane after being washed with water is subjected to an after-treatment so that it becomes a preferred state for a step of making into a composite membrane which will be mentioned later. For example, a preferable after-treatment is a pore-filling treatment wherein a liquid such as alcohol, alkylene diol or triol, alkylene glycol alkyl ether or water or a mixed liquid thereof is impregnated with a porous support membrane to fill the pores in the support membrane. As a result of the pore-filling treatment, it is possible to solve such a problem that, when a coating liquid is applied in a step of making into a composite state, SPAE molecules are excessively permeated into a porous support membrane so that water permeation property lowers. Moreover or alternatively, a liquid used for the pore-filling treatment acts as a retaining agent for pore size whereby drying/shrinking of the porous support membrane can be suppressed and/or the porous support membrane which is hydrophobic can be kept in a hydrophilized state.

It is preferred that excessive water and solvent in the porous support membrane being subjected to the above pore-filling treatment are appropriately dried. Conditions for this drying should be appropriately adjusted so as to make the property as a composite separation membrane adequate. To be more specific, it is preferred to dry for about 0.01 second to one night at the temperature of 20 to 200° C.

The resulting porous support membrane is rolled by a winding apparatus, stored and, later, it may be taken out from a rolled state as a separate step and then subjected to a step for making into composite. Alternatively, it may be subjected to a compositing step while being continuously conveyed without using a winding apparatus.

Thickness of a porous support membrane used for a composite separation membrane is preferred to be from 5 μm to 500 μm. When it is thinner than this range, a problem that resistance to pressure is not well secured is apt to happen while, when it is thicker than the range, resistance to water permeation becomes big whereby it is not preferred. It is more preferred to be from 10 μm to 100 μm. In the case of a porous support membrane of a hollow fiber shape, outer diameter of the membrane is preferred to be from 50 μm to 2000 μm. When it is smaller than this range, fluid pressure loss of a permeation liquid or a supply liquid flowing in the bore side of the hollow becomes too big and operation pressure becomes too big whereby it is not preferred. When it is bigger than the range, resistance of the membrane to pressure lowers whereby it is not preferred. It is more preferred to be from 80 μm to 1500 μm.

It is preferred that the SPAE used for a separation layer of the composite separation membrane of the present invention is such a polymer which is prepared by copolymerization of a combination of a hydrophilic monomer having a sulfonic group with a hydrophobic monomer having no sulfonic group. In this SPAE, it is possible to suitably select each of chemical structures for the hydrophilic monomer having a sulfonic group and for the hydrophobic monomer. To be more specific, when a chemical structure having high rigidity is appropriately selected, a SPAE separation layer which is hardly swollen and is firm can be formed. Further, when a charging amount of each monomer is adjusted in a copolymerization reaction, the amount of sulfonic group introduced thereinto can be precisely controlled with good reproducibility. As to another method for the production of SPAE, there is such a means wherein known polyarylene ether is sulfonated using sulfuric acid. However, this means has such problems that a precise control of introduction amount of sulfonic group is difficult and that a decrease in molecular weight is apt to happen during the reaction whereby it is not preferred. As to the structure of SPAE prepared by a direct copolymerization, preferable one is such a structure wherein a fundamental structure is a polymer constituted from a repeating structure of a hydrophobic segment represented by the following formula (IV) having benzene rings connected with each other by ether bond and a hydrophilic segment represented by the following formula (V). This is because it expresses a rigid molecular structure and an excellent resistance to chemicals. Moreover, in a fundamental structure of the following formulae (IV) and (V), particularly in such a case wherein x, Y, Z and W are selected from the following combination, the whole molecular structure becomes more rigid, a polymer having a high glass transition temperature can be prepared and good resistance to chemicals can be also maintained whereby it is preferred.

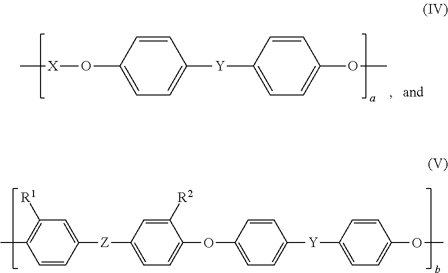

wherein X is either the following formula (VIII) or (IX):

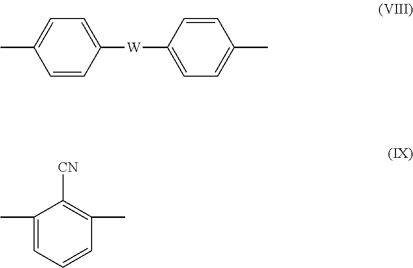

wherein Y is a single bond or any of the following formulae (X)-(XIII):

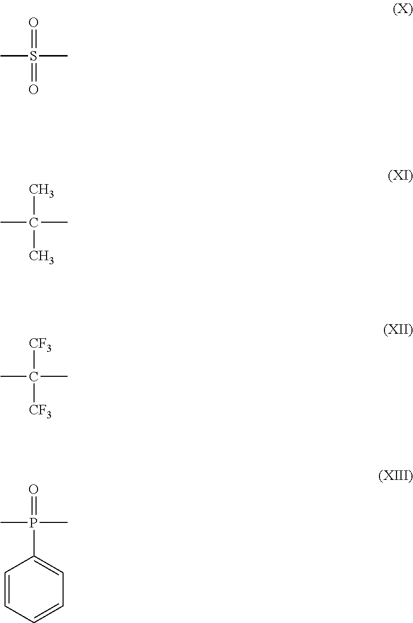

wherein Z is a single bond or any of the following formulae (X), (XIV) and (XIII):

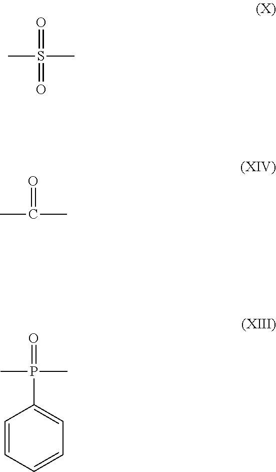

wherein W is a single bond or any of the following formulae (X), (XIV) and (XIII):

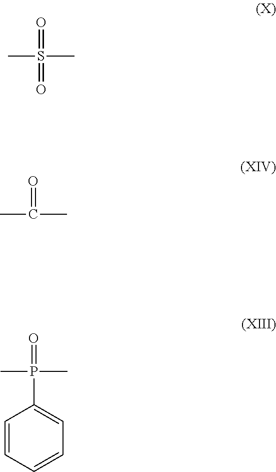

wherein Y and W are not selected as the same thing;

wherein a and b each represents a natural number of 1 or more;

wherein R¹ and R² each represents —SO₃M or —SO₃H, wherein M represents a metal element; and

wherein a sulfonation rate in terms of a percent rate of repeating number of the formula (V) in the sulfonated polyarylene ether copolymer to total of repeating number of the formula (IV) and repeating number of the formula (V) in the sulfonated polyarylene ether copolymer is more than 10% and less than 70%.

Although SPAE can be prepared by the known methods, it also can be prepared, for example, by polymerization using an aromatic nucleophilic substitution reaction containing a compound of the above formula [IV] and a compound of the above formula [V] as monomers. In conducting the polymerization by an aromatic nucleophilic substitution reaction, it is possible to react activated difluoro aromatic compound and/or dichloro aromatic compound containing the compound of the formula [IV] and the compound of the formula [V] with an aromatic diol compound in the presence of a basic compound. Although the reaction can be conducted at the temperature range of 0 to 350° C., the temperature is preferred to be 50 to 250° C. When the temperature is lower than 0° C., there is a tendency that the reaction does not well proceeds while, when it is higher than 350° C., there is a tendency that decomposition of polymer is also apt to happen. Although the reaction can be conducted in the absence of a solvent, it is preferred to be conducted in a solvent. Examples of the usable solvent include N-methyl-2-pyrrolidone, N,N-dimethylacetamide, N,N-dimethyl-formamide, dimethyl sulf oxide, diphenyl sulfone and sulfolane although the present invention is not limited thereto but any solvent which can be used as a stable solvent in an aromatic nucleophilic substitution reaction may be used. As to the organic solvents as such, one of them may be used solely or two or more thereof may be used as a mixture. Examples of the basic compound include sodium hydroxide, potassium hydroxide, sodium carbonate, potassium carbonate, sodium hydrogen carbonate and potassium hydrogen carbonate and any compound other than the above may be used so far as it can convert an aromatic diol into an active phenoxide structure. In the aromatic nucleophilic substitution reaction, water may be produced as a by-product. In that case, it is also possible that toluene or the like is made to coexist in the reaction system in addition to the polymerization solvent so that water can be removed to the outside as an azeotropic substance. As to a method of removing the water to the outside, a water-absorbing material such as molecular sieve may be used as well. When an aromatic nucleophilic substitution reaction is conducted in a solvent, it is preferred to charge a monomer so that the resulting polymer concentration becomes 5 to 50% by mass. When it is less than 5% by mass, degree of polymerization tends to hardly rise. On the other hand, when it is more than 50% by mass, there is a tendency that viscosity of the reaction solution becomes too high whereby the after-treatment of the reaction product become difficult. After completion of the polymerization reaction, the solvent is removed from the reaction solution by means of evaporation and the residue is washed depending on necessity whereby a desired polymer is prepared. It is also possible that the reaction solution is added to a solvent in which solubility of the polymer is low whereby the polymer is precipitated as a solid followed by filtering the precipitate to give a polymer.

Ion exchange capacity (IEC; milli-equivalent of sulfonic group per 1 g of SPAE) of the SPAE having the above chemical structure being preferred for the use as a composite separation membrane is 0.5 to 3.0 meq./g and the preferred range of degree of sulfonation (DS) is more than 10% and less than 70%. Further, it is preferred that glass transition temperature T_{g} of the polymer in a dry state which is an index for rigidity of the SPAE molecule is 150° C. to 450° C. when measured by a measuring method according to differential scanning calorimetry which will be mentioned later. When the IEC and DS are lower than the above ranges, water permeation property cannot be well expressed since content of sulfonic group is too small. When the IEC and DS are higher than the above ranges, hydrophilicity of the polymer becomes too much and an SPAE separation layer excessively swells whereby no separation property is expressed.

It is more preferred that the SPAE used for a separation layer of the present invention is constituted from a repeating structure of a hydrophobic segment represented by the following formula (I) and a hydrophilic segment represented by the following formula (II):

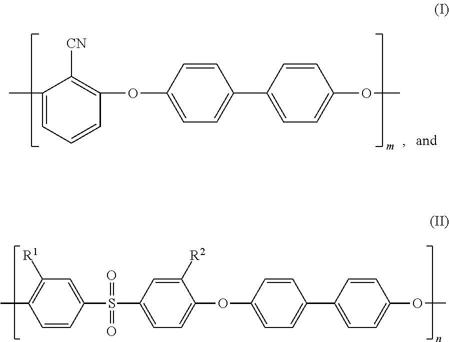

In the above formulae, m and n each represents a natural number of 1 or more; R¹ and R² each represents —SO₃M or —SO₃H, wherein M represents a metal element; and a sulfonation rate in terms of a percent rate of repeating number of the formula (II) in the sulfonated polyarylene ether copolymer to total of repeating number of the formula (I) and repeating number of the formula (II) in the sulfonated polyarylene ether copolymer is more than 10% and less than 70%.

R¹ and R² each in the above formulae (II) and (V) stands for —SO₃H or —SO₃M. A metal element M in the latter case is not particularly limited and preferred examples thereof include potassium, sodium, magnesium, aluminum and cesium. More preferred examples of the metal element M include potassium and sodium.

Number-average molecular weight of SPAE represented by the above formulae (I) and (II) as well as (IV) and (V) is preferred to be 1,000 to 1,000,000 in such a view that viscosity of a coating solution is made adequate and that a thin film having sufficient separation property and mechanical strength as a separation layer is formed.

In the SPAE represented by the above formulae (I) and (II) as well as (IV) and (V), rigidity of its molecular structure is high whereby it is possible to form a separation layer having high mechanical strength and being hardly swollen. Accordingly, it is excellent as a composite separation membrane. Further, since the SPAE represented by the above formulae (I) and (II) contains a benzonitrile structure in a hydrophobic segment represented by the formula (I), it has an excellent resistance to chemicals and a cohesive force of the hydrophobic part thereof becomes strong, leading to formation of a separation layer wherein a hydrophilic domain is supported by a firm hydrophobic matrix. As a result, there is achieved a characteristic that swelling of a separation layer is suppressed.

As to a coating solvent for the above SPAE, the preferred one is a solvent containing at least one component selected from dimethyl sulfoxide, N,N-dimethylacetamide, N,N-dimethylformamide, N-methyl-2-pyrrolidone and γ-butyrolactone which are aprotic polar solvents of the solvent group 1. Further, among the solvents of the solvent group 1, dimethyl sulfoxide and γ-butyrolactone are more preferred since they do not dissolve the above-mentioned polyphenylene ether porous support membrane even at high temperature. In addition, a solvent prepared by mixing dimethyl sulfoxide or γ-butyrolactone with any of N,N-dimethylacetamide, N,N-dimethylformamide and N-methyl-2-pyrrolidone may be preferably used as well. Moreover, the structure of a separation layer in a composite separation membrane may be controlled by such means that a solvent having inferior solubility or a solvent having different vapor pressure is added to a solvent of a solvent group 1 to modify the evaporation rate of a coating solution and/or to modify the stability of a solution. For example, a solvent of a solvent group 2 may be contained in a solvent of a solvent group 1.

It is also possible to add known hydrophilic polymers such as polyethylene glycol and polyvinylpyrrolidone thereto in order to modify the viscosity and the hydrophilicity of a coating solution of SPAE. The use of such additives should be conducted as a means within a usual range for making the property of a composite separation membrane adequate by such a manner that, in a coating step, a coating solution just in an appropriate amount is applied on the surface of a porous support membrane and/or that the membrane structure of a composite separation membrane is controlled.

Concentration of the SPAE in a coating solution is not particularly limited but should be appropriately adjusted in order to control the thickness of a separation layer in a composite separation membrane. Although the final thickness of a separation layer is affected, for example, by the applying speed of a coating solution on the surface of a porous support membrane and by the temperature at that time, concentration of the SPAE is preferred to be 0.01 to 10% by mass and more preferred to be 0.1 to 5% by mass. When concentration of the SPAE is smaller than this range, thickness of a separation layer is too thin and defect is apt to happen whereby it is not preferred. When it is larger than this range, since thickness of a separation layer is too large and resistance to filtering becomes big, no sufficient water permeation property as a composite separation membrane is achieved whereby it is not preferred. The final thickness of the SPAE separation layer is preferred to be 50 nm to 500 nm and more preferred to be 100 nm to 300 nm.

There is no particular limitation for a method of applying the above-mentioned coating solution on the surface of a porous support membrane but known means may be used. For example, in the case of a flat sheet membrane, a simple method wherein a coating solution is applied on the surface of a porous support membrane using a brush by hand is preferred. As to a more industrial method, it is preferred to use a method wherein a coating solution is applied by a slide bead coater on the surface of a porous support membrane which is continuously conveyed. In the case of a hollow fiber membrane, it is preferred to use a dip-coating method wherein a hollow fiber membrane being continuously conveyed is dipped in a bath filed with a coating solution and then pulled out so as to apply the solution onto the outer surface of the hollow fiber membrane. Alternatively, it is also preferred to use a method wherein a coating solution is inserted into a hollow fiber membrane from the cross section of a module prepared by bundling the hollow fiber membrane and then the coating solution is extruded using gas or it is pulled out in vacuo from one side of the module so as to apply the coating solution onto the inner surface of the hollow fiber membrane.

A coating solution applied onto the surface of a porous support membrane is subjected to a drying treatment whereby a thin film of SPAE is formed. Although there is no particular limitation for a drying method, there may be used, for example, a method wherein a porous support membrane subjected to a coating treatment is passed for predetermined time into a drying furnace subjected to compulsory convection. Drying temperature is a condition which is to be appropriately adjusted so that the property of a composite separation membrane is made into a specific desired value. When preparing a composite membrane having suitable membrane properties as a nanofiltration membrane, the drying temperature is preferably 60° C.-200° C., and more preferably 80° C.-180° C. When the drying temperature is lower than the above range, the drying time needs to be set excessively long or the solvent cannot be dried and, accordingly, that is not preferred. When the drying temperature is higher than the above range, there is a risk that structure of the porous support membrane is destroyed due an excessive high temperature and, accordingly, that is not preferred.

Although the values demanded as the membrane properties of a composite separation membrane in a practical view may vary depending upon size of a fractionated object, affinity to membrane, operation pressure, salt concentration and fouling (degree of becoming dirty) of membrane and are not always definite, it is preferred that, as a nanofiltration membrane, NaCl rejection rate is from 20% to less than 93%, and MgSO₄ rejection rate is 70% or more, more preferably 90% or more, and further preferably 95% or more.

### EXAMPLES

As hereunder, the present will be illustrated by referring to Examples although the present invention is not limited at all by those Examples. Incidentally, measurement of the characteristic values measured in Examples was conducted according to the following methods.

<Evaluation of SPAE Polymers>

Degree of sulfonation, ion exchange capacity (IEC) and glass transition temperature of SPAE polymers were evaluated as follows.

(IEC)

Weight of an SPAE polymer dried for one night under a nitrogen atmosphere was measured. Then the polymer was subjected to a stirring treatment with an aqueous solution of sodium hydroxide and to a back titration using an aqueous solution of hydrochloric acid to evaluate the ion exchange capacity (IEC).

(Degree of Sulfonation)

A polymer (10 mg) dried at 120° C. in a vacuum drier for one night was dissolved in 1 ml of deuterized DMSO (DMSO-d6) and subjected to a proton NMR using Bruker Avance 500 (frequency: 500.13 MHz; measuring temperature: 30° C.; FT integration: 32 times). In the resulting spectral chart, relation between proton contained in each of hydrophobic segment and hydrophilic segment and peak positions was identified and the sulfonation degree was determined from the ratio of integral strength per proton of the independent peak in the hydrophobic segment and the independent peak in the hydrophilic segment.

(Glass Transition Temperature)

Glass transition temperature of the SPAE polymer powder in a dry state was evaluated by means of a differential scanning calorimetry (DSC). Specifically, a polymer sample was filled in a sample pan made of aluminum and measured using a Q100 manufactured by TA Instrument. As the first scan, temperature was raised to such an extent that the SPAE was not thermally degraded followed by cooling and, in the second scan wherein the temperature was raised again, glass transition temperature was evaluated. Since the data for water contained in the polymer were contaminated in the first scan, the second scan was adopted for excluding the influence of water on the data. To be more specific, temperature was raised from 20° C. up to 320° C. at 20° C./min and lowered down to 20° C. at 20° C./min. After that, as the second scan, the temperature was raised again from 20° C. up to 450° C. at 20° C./min. With regard to the glass transition temperature, central point of the changing steps for heat capacity was evaluated using Universal Analysis 2000 manufactured by TA Instrument. However, since thermostability of the polymer may vary depending upon the chemical structure of SPAE, the reaching temperature in the first scan is to be limited, if necessary, to such an extent that the polymer is not significantly deteriorated. Thus, decomposing temperature of the polymer is checked in advance by means of thermogravimetric analysis (TGA) and the above-mentioned reaching temperature of the first scan is adjusted. As a rough yardstick, it is made lower than the temperature wherein 5% reduction in weight of the polymer takes place in an atmosphere of inert gas.

<Method for Evaluation of Membrane Properties of Composite Separation Membrane>

Composite separation membranes were subjected to evaluation of membrane shape, evaluation of separation layer thickness and evaluations of separation property and permeation property according to the following methods.

(Shape of Porous Support Membrane)

Evaluation of the shape of porous support membrane samples (hollow fiber) of Examples 1 to 9 was conducted by the following method. Thus, an SUS plate of 2 mm thickness wherein pores of 3 mm diameter were formed was provided. Then, an appropriate amount of hollow fiber bundles was filled in the pores and cut using a blazer to expose the cross section of the hollow fiber bundles, then a picture of the shape of the cross section was taken using a microscope (ECLIPSE LV100) manufactured by Nikon, an image processing apparatus (DIGITAL SIGHT DS-U2) and a CCD camera (DS-Ri1) made by Nikon. Then outer and inner diameters of the cross section of the hollow fiber were measured by means of a measuring function of the analysis software (NIS Element D3.00 SP6) whereby the outer and inner diameters and thickness of the hollow fiber membrane were calculated. Evaluation of shape of the porous support membrane sample (flat sheet membrane) of Example 10 was conducted in such a manner that a sample in a state of containing water was frozen with liquid nitrogen, cut/broken and dried with air. Pt was subjected to sputtering to the resulting cut/broken area. Observation was conducted under a scanning electron microscope S-4800 manufactured by Hitachi with an accelerated voltage of 5 kV whereby the thickness of the porous support membrane excluding the area of nonwoven fabric of polyester was measured.

(Thickness of Separation Layer of Composite Separation Membrane Sample)

Composite separation membranes of Examples 1 to 10 were subjected to a hydrophilizing treatment using a 50% aqueous solution of ethanol, immersed into water, frozen, cut/broken and dried with air. Pt was subjected to sputtering to the resulting cut/broken area. Observation was conducted under a scanning electron microscope S-4800 manufactured by Hitachi with an accelerated voltage of 5 kV. FIG. 1 shows a picture of the composite separation membrane of Example 1 under an SEM as an example of the SEM pictures. Thickness of the separation layer was measured by taking the picture of the outer layer part of the membrane.

(NaCl Separation Property and Permeation Property of Composite Separation Membrane)

After the hollow fiber membranes of any of Examples 1-9 were bundled and inserted into a sleeve made of plastic, thermosetting resin was injected into the sleeve and hardened to seal. Terminal of the hollow fiber membrane hardened by the thermosetting resin was cut to give an opening of the hollow fiber membrane whereby there was prepared a module for the evaluation. This module for the evaluation was connected to a device for testing properties of hollow fiber membrane comprising a tank for feed water and a pump, and the properties were evaluated. The flat sheet membrane of Example 10 was set on a device for evaluating properties of flat sheet membrane comprising a tank for feed water and a pump similar to the above device, and the properties were evaluated. As an evaluation condition, a feed aqueous solution having sodium chloride concentration of 1500 mg/L was operated at 25° C., 0.5 MPa pressure and for about 30 minutes to 1 hour (s). After that, water permeated through the membrane was collected and weight of permeated water was measured by an electron balance (LIBROR EB-3200D manufactured by Shimadzu). The weight of permeated water was converted to amount of permeated water at 25° C. according to the following formula:

amount of permeated water (L)=weight of permeated water (kg)/0.99704 (kg/L)

Permeation flow rate (FR) is calculated by the following formula:

FR [L/m²/day]=amount of the permeated water (L)/membrane area [m²]/collecting time [minutes]×(60 [minutes]×24 [hours])

Sodium chloride concentration was measured using a conductometric detector (CM-25R by Toa DKK) from the permeated water collected in the above measurement for permeation flow rate and the feed aqueous solution having sodium chloride concentration of 1,500 mg/L used for the same measurement of permeation flow rate.

Salt rejection is calculated by the following formula:

salt rejection [%]=(1−salt concentration of permeated water [mg/L]/salt concentration of feed aqueous solution [mg/L])×100

(MgSO₄ separation property and permeation property of composite separation membrane)

After the hollow fiber membranes of any of Examples 1-9 were bundled and inserted into a sleeve made of plastic, thermosetting resin was injected into the sleeve and hardened to seal. Terminal of the hollow fiber membrane hardened by the thermosetting resin was cut to give an opening of the hollow fiber membrane whereby there was prepared a module for the evaluation. This module for the evaluation was connected to a device for testing properties of hollow fiber membrane comprising a tank for feed water and a pump, and the properties were evaluated. The flat sheet membrane of Example 10 was set on a device for evaluating properties of flat sheet membrane comprising a tank for feed water and a pump similar to the above device, and the properties were evaluated. As an evaluation condition for rejection, a feed aqueous solution having magnesium sulfate concentration of 500 mg/L was operated at 25° C., 0.5 MPa pressure and for about 30 minutes to 1 hour(s). After that, water permeated through the membrane was collected and weight of permeated water was measured by an electron balance (LIBROR EB-3200D manufactured by Shimadzu). The weight of permeated water was converted to amount of permeated water at 25° C. according to the following formula:

amount of permeated water (L)=weight of permeated water (kg)/0.99704 (kg/L)

Permeation flow rate (FR) is calculated by the following formula:

FR [L/m²/day]=amount of the permeated water (L)/membrane area [m²]/collecting time [minutes]×(60 [minutes]×24 [hours])

Magnesium sulfate concentration was measured using a conductometric detector (CM-25R by Toa DKK) from the permeated water collected in the above measurement for permeation flow rate and the feed aqueous solution having magnesium sulfate concentration of 500 mg/L used for the same measurement of permeation flow rate.

Salt rejection is calculated by the following formula:

salt rejection [%]=(1−salt concentration of permeated water [mg/L]/salt concentration of feed aqueous solution [mg/L])×100

<Measuring Method by Proton NMR>

Measurement was conducted by proton NMR for a composite separation membrane whereby the value of “a” was calculated.

A composite separation membrane is provided which has been previously washed with water and dried at 60° C. for 4 hours. Twenty composite separation membrane samples are prepared by cutting the above composite separation membrane into 7 cm length. A deuterated chloroform solution containing 2% by mass of tetramethylsilane as an internal standard substance for the NMR measurement is sealed into a capillary and the above-prepared 20 composite separation membrane samples are inserted into an NMR tube of 5 mm diameter and then allowed to stand for 120 hours in a thermohygrostat which is kept at 40° C. temperature and 80% relative humidity so as to make into a water-containing state. The above composite separation membrane samples in a water-containing state are subjected to a proton NMR measurement using Avance 500 manufactured by Bruker (resonance frequency: 500.13 MHz; measuring temperature: −10° C.; FT integration: 64 times; waiting time: 5 seconds). At that time, a waiting period of 60 minutes is set for the stabilization of temperature after the temperature reached −10° C. FIG. 1 shows an example of the proton NMR spectral charts. Among the spectral peaks observed at that time, the peak appearing in the highest magnetic field side is a spectral peak derived from tetramethylsilane and this peak top is taken as 0 ppm and adopted as a standard. A peak which appears in a lower magnetic field side is a peak derived from water in the membrane. Chemical shift of the peak top of the spectral peak derived from water in the membrane when measurement is conducted at −10° C. is taken as “a” (ppm).

### Example 1

### Preparation of Porous Support Membrane

As a polymer for a porous support membrane, Polyphenylene Ether PX100L (hereinafter, abbreviated as PPE) manufactured by Mitsubishi Engineering Plastic KK was provided. N-Methyl-2-pyrrolidone (hereinafter, abbreviated as NMP) was added thereto so as to make PPE content 30% by mass. The resulting mixture was dissolved at 140° C. with kneading to give a homogeneous dope for membrane preparation.

After that, the dope for membrane preparation was kept at the temperature of 75° C., and extruded from a double cylindrical nozzle into a hollow shape. At the same time, a 70% by mass aqueous solution of NMP was extruded as an inner liquid. The resulting one was made to run in air of ordinary room temperature for a drying treatment, and then immersed in a coagulation bath of 40° C. filled with a 35% by mass aqueous solution of NMP. The resulting PPE porous support membrane was subjected to a washing treatment with water.

The porous support membrane washed with water was impregnated with a 50% by mass aqueous solution of glycerol, dried at 40° C., and rolled around a winder.

Outer diameter and membrane thickness of the resulting PPE porous support membrane were 260 μm and 45 μm, respectively. As a result of pure water permeability test, permeation flow rate FR of the pure water was 5200 L/m²/day under the test pressure of 0.5 MPa.

(Preparation of Composite Separation Membrane)

SPAE having a repeating structure of a hydrophobic segment represented by the above formula (I) and a hydrophilic segment represented by the above formula (II) was prepared as follows.

3,3′-disulfo-4,4′-dichlorodiphenylsulfone disodium. salt (hereinafter, abbreviated as S-DCDPS) (15.00 g), 29.76 g of 2,6-dichlorobenzonitrile (hereinafter, abbreviated as DCBN), 37.91 g of 4,4′-biphenol (hereinafter, abbreviated as BP), and 30.95 g of potassium carbonate were weighed in a 1000 mL four-necked flask equipped with a cooling reflux tube. Nitrogen was flown thereinto at 0.5 L/min. N-methyl-2-pyrrolidone (hereinafter, abbreviated as NMP) (263 mL) was added thereto. The flask was put in an oil bath, and heated to 150° C. The contents were stirred at 150° C. for 30 minutes. After that, temperature was raised up to 210° C., and the reaction was conducted for 12 hours. After that, the system was allowed to cool. After that, the polymerization reaction solution was precipitated into water in a strand-like form. The resulting polymer was washed with water at ordinary room temperature for 6 times, and dried in vacuo at 110° C. Degree of sulfonation (hereinafter, abbreviated as DS) was measured. As a result, it was found that SPAE having DS of 15.0% was prepared.

A glass transition temperature T_{g} of the SPAE polymer was evaluated and found to be T_{g}=244° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

A DMSO solvent was added to the resulting SPAE. The resulting mixture was stirred at ordinary room temperature and dissolved to give a coating solution of 3% by mass concentration.

The PPE porous support membrane was passed through the coating solution, dried at 115° C., and rolled around a winder at the rate of 1.5 m/minute.

The resulting composite separation membrane was subjected to an NMR measurement. As a result, it was found that “a” was 4.19 ppm.

The resulting composite separation membrane was immersed into ethanol for 30 minutes to carry out a hydrophilizing treatment, and then subjected to a test for evaluating the property. Permeation flow rate was 42 L/m²/day and salt rejection was 84.0% under the condition wherein the test pressure was 0.5 MPa and the sodium chloride concentration was 1500 mg/L. Permeation flow rate was 45 L/m²/day and salt rejection was 99.6% under the condition wherein the test pressure was 0.5 MPa and the magnesium sulfate concentration was 500 mg/L.

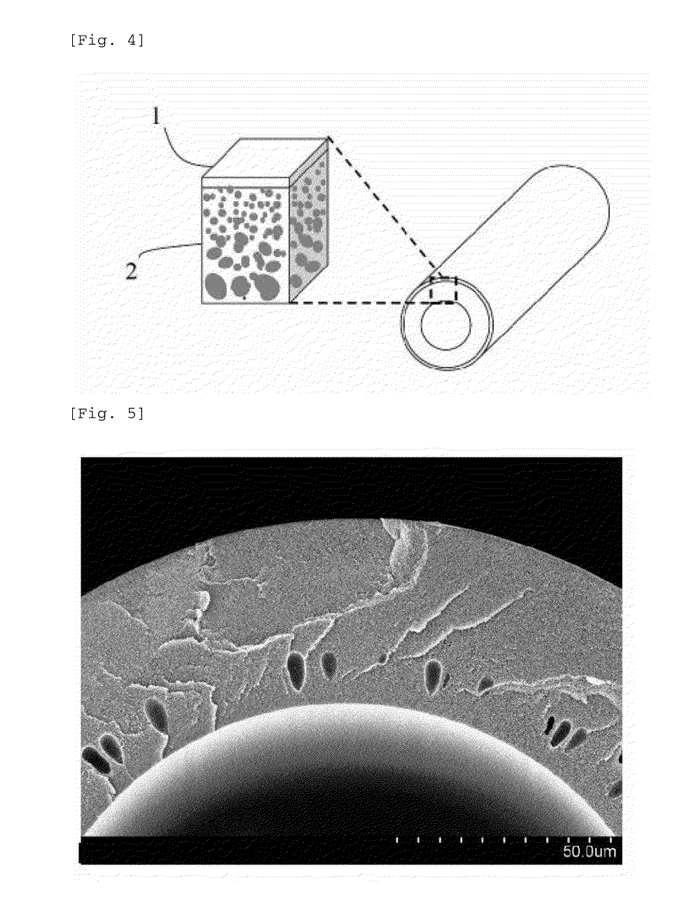

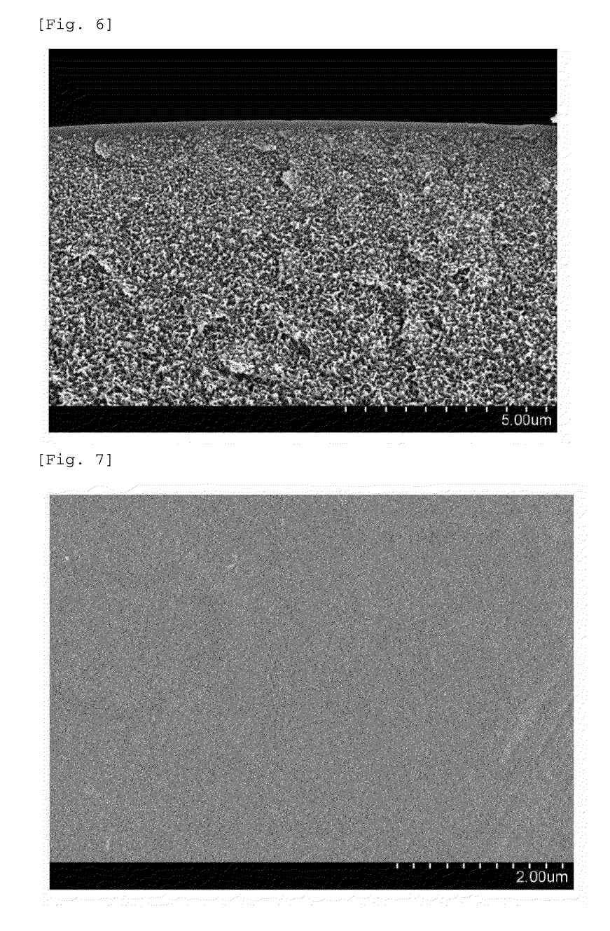

As a result of an observation under an SEM, thickness of an SPAE separation layer in the resulting composite separation membrane was 160 nm. An SEM image of the cross section of the membrane, an enlarged SEM image of the outer layer part of the cross section of the membrane, and an enlarged SEM image of the membrane surface are shown in FIGS. 3 to 5, respectively.

### Example 2

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 5200 L/m²/day under the test pressure of 0.5 MPa.

(Preparation of Composite Separation Membrane)

The same operation as in Example 1 was conducted whereby SPAE having DS of 15.0% was prepared.

A glass transition temperature T_{g} of the SPAE polymer was evaluated and found to be T_{g}=244° C. Solubility of the resulting SPAE polymer in 2-methoxyethanol, formic acid and diethylene glycol as the solvents of the solvent group 2 was tested, but no solubility was achieved. The resulting SPAE polymer could be dissolved in any of NMP, DMAc, GBL, DMF and DMSO which are the solvent group 1.

The same operation as in Example 1 was conducted except that the drying temperature was changed to 80° C. whereby composite separation membrane was prepared. The resulting composite separation membrane was subjected to an NMR measurement. As a result, it was found that “a” was 4.72 ppm.

The resulting composite separation membrane was subjected to a test for evaluating the property. Permeation flow rate was 750 L/m²/day and salt rejection was 35.0% under the condition wherein the test pressure was 0.5 MPa and the sodium chloride concentration was 1500 mg/L. Permeation flow rate was 155 L/m²/day and salt rejection was 78.2% under the condition wherein the test pressure was 0.5 MPa and the magnesium sulfate concentration was 500 mg/L.

As a result of an observation under an SEM, thickness of an SPAE separation layer in the resulting composite separation membrane was 140 nm.

### Example 3

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 5300 L/m²/day under the test pressure of 0.5 MPa.

(Preparation of Composite Separation Membrane)

S-DCDPS (35.00 g), 15.60 g of DCBN, 30.15 g of BP, and 24.26 g of potassium carbonate were weighed in a 1000 mL four-necked flask equipped with a cooling reflux tube. Nitrogen was flown thereinto at 0.5 L/min. NMP (268 mL) was added thereto. The flask was put in an oil bath, and heated to 150° C. The contents were stirred at 150° C. for 30 minutes. After that, temperature was raised up to 210° C., and the reaction was conducted for 12 hours. After that, the system was allowed to cool. After that, the polymerization reaction solution was precipitated into water in a strand-like form. The resulting polymer was washed with water at ordinary room temperature for 6 times, and dried in vacuo at 110° C. As a result of DS measurement, it was found that SPAE having DS of 44.0% was prepared.

A glass transition temperature T_{g} of the SPAE polymer was evaluated and found to be T_{g}=322° C. Solubility of the resulting SPAE polymer in 2-methoxyethanol, formic acid and diethylene glycol as the solvents of the solvent group 2 was tested, but no solubility was achieved. The resulting SPAE polymer could be dissolved in any of NMP, DMAc, GBL, DMF and DMSO which are the solvent group 1.

The same operation as in Example 1 was conducted except that the drying temperature was changed to 110° C. whereby composite separation membrane was prepared. The resulting composite separation membrane was subjected to an NMR measurement. As a result, it was found that “a” was 4.92 ppm.

The resulting composite separation membrane was subjected to a test for evaluating the property. Permeation flow rate was 1200 L/m²/day and salt rejection was 25.0% under the condition wherein the test pressure was 0.5 MPa and the sodium chloride concentration was 1500 mg/L. Permeation flow rate was 240 L/m²/day and salt rejection was 71.8% under the condition wherein the test pressure was 0.5 MPa and the magnesium sulfate concentration was 500 mg/L.

As a result of an observation under an SEM, thickness of an SPAE separation layer in the resulting composite separation membrane was 150 nm.

### Example 4

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 5250 L/m²/day under the test pressure of 0.5 MPa.

(Preparation of Composite Separation Membrane)

The same operation as in Example 3 was conducted whereby SPAE having DS of 44% was prepared.

A glass transition temperature T_{g} of the SPAE polymer was evaluated and found to be T_{g}=322° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

The same operation as in Example 1 was conducted except that the drying temperature was changed to 175° C. whereby composite separation membrane was prepared. The resulting composite separation membrane was subjected to an NMR measurement. As a result, it was found that “a” was 4.55 ppm.

The resulting composite separation membrane was subjected to a test for evaluating the property. Permeation flow rate was 400 L/m²/day and salt rejection was 60.2% under the condition wherein the test pressure was 0.5 MPa and the sodium chloride concentration was 1500 mg/L. Permeation flow rate was 120 L/m²/day and salt rejection was 91.2% under the condition wherein the test pressure was 0.5 MPa and the magnesium sulfate concentration was 500 mg/L.

As a result of an observation under an SEM, thickness of an SPAE separation layer in the resulting composite separation membrane was 140 nm.

### Example 5

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 5000 L/m²/day under the test pressure of 0.5 MPa.

(Preparation of Composite Separation Membrane)

S-DCDPS (45.00 g), 8.48 g of DCBN, 26.24 g of BP, and 21.43 g of potassium carbonate were weighed in a 1000 mL four-necked flask equipped with a cooling reflux tube. Nitrogen was flown thereinto at 0.5 L/min. NMP (270 mL) was added thereto. The flask was put in an oil bath, and heated to 150° C. The contents were stirred at 150° C. for 30 minutes. After that, temperature was raised up to 210° C., and the reaction was conducted for 12 hours. After that, the system was allowed to cool. After that, the polymerization reaction solution was precipitated into water in a strand-like form. The resulting polymer was washed with water at ordinary room temperature for 6 times, and dried in vacuo at 110° C. As a result of DS measurement, it was found that SPAE having DS of 65.0% was prepared.

A glass transition temperature T_{g} of the SPAE polymer was evaluated and found to be T_{g}=399° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

The same operation as in Example 4 was conducted whereby composite separation membrane was prepared. The resulting composite separation membrane was subjected to an NMR measurement. As a result, it was found that “a” was 4.68 ppm.

The resulting composite separation membrane was subjected to a test for evaluating the property. Permeation flow rate was 700 L/m²/day and salt rejection was 38.4% under the condition wherein the test pressure was 0.5 MPa and the sodium chloride concentration was 1500 mg/L. Permeation flow rate was 105 L/m²/day and salt rejection was 78.8% under the condition wherein the test pressure was 0.5 MPa and the magnesium sulfate concentration was 500 mg/L.

As a result of an observation under an SEM, thickness of an SPAE separation layer in the resulting composite separation membrane was 160 nm.

### Example 6

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 5100 L/m²/day under the test pressure of 0.5 MPa.

(Preparation of Composite Separation Membrane)

The same operation as in Example 1 was conducted whereby SPAE having DS of 15.0% was prepared.

A glass transition temperature T_{g} of the SPAE polymer was evaluated and found to be T_{g}=244° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

A GBL solvent was added to the resulting SPAE. The resulting mixture was stirred at ordinary room temperature and dissolved to give a coating solution of 3% by mass concentration.

The same operation as in Example 1 was conducted whereby composite separation membrane was prepared. The resulting composite separation membrane was subjected to an NMR measurement. As a result, it was found that “a” was 4.18 ppm.

The resulting composite separation membrane was subjected to a test for evaluating the property. Permeation flow rate was 58 L/m²/day and salt rejection was 82.5% under the condition wherein the test pressure was 0.5 MPa and the sodium chloride concentration was 1500 mg/L. Permeation flow rate was 55 L/m²/day and salt rejection was 99.5% under the condition wherein the test pressure was 0.5 MPa and the magnesium sulfate concentration was 500 mg/L.

As a result of an observation under an SEM, thickness of an SPAE separation layer in the resulting composite separation membrane was 160 nm.

### Example 7

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 4990 L/m²/day under the test pressure of 0.5 MPa.

(Preparation of Composite Separation Membrane)

The same operation as in Example 1 was conducted whereby SPAE having DS of 15.0% was prepared.

A glass transition temperature T_{g} of the SPAE polymer was evaluated and found to be T_{g}=244° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

To the resulting SPAE was added a mixed solvent having the ratio by weight of NMP to DMSO of 50:50, and dissolved with stirring at ordinary room temperature whereby a coating solution of 3% by mass concentration was prepared.

The same operation as in Example 1 was conducted whereby composite separation membrane was prepared. The resulting composite separation membrane was subjected to an NMR measurement. As a result, it was found that “a” was 4.20 ppm.

The resulting composite separation membrane was subjected to a test for evaluating the property. Permeation flow rate was 46 L/m²/day and salt rejection was 84.0% under the condition wherein the test pressure was 0.5 MPa and the sodium chloride concentration was 1500 mg/L. Permeation flow rate was 43 L/m²/day and salt rejection was 99.6% under the condition wherein the test pressure was 0.5 MPa and the magnesium sulfate concentration was 500 mg/L.

As a result of an observation under an SEM, thickness of an SPAE separation layer in the resulting composite separation membrane was 150 nm.

### Example 8

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 4990 L/m²/day under the test pressure of 0.5 MPa.

(Preparation of Composite Separation Membrane)

The same operation as in Example 1 was conducted whereby SPAE having DS of 15.0% was prepared.

A glass transition temperature T_{g} of the SPAE polymer was evaluated and found to be T_{g}=244° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

To the resulting SPAE was added a mixed solvent having the ratio by weight of diethylene glycol to DMSO of 50:50, and dissolved with stirring at ordinary room temperature whereby a coating solution of 3% by mass concentration was prepared.

The same operation as in Example 1 was conducted whereby composite separation membrane was prepared. The resulting composite separation membrane was subjected to an NMR measurement. As a result, it was found that “a” was 4.18 ppm.

The resulting composite separation membrane was subjected to a test for evaluating the property. Permeation flow rate was 59 L/m²/day and salt rejection was 81.5% under the condition wherein the test pressure was 0.5 MPa and the sodium chloride concentration was 1500 mg/L. Permeation flow rate was 57 L/m²/day and salt rejection was 99.5% under the condition wherein the test pressure was 0.5 MPa and the magnesium sulfate concentration was 500 mg/L.

As a result of an observation under an SEM, thickness of an SPAE separation layer in the resulting composite separation membrane was 180 nm.

### Example 9

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 5230 L/m²/day under the test pressure of 0.5 MPa.

(Preparation of Composite Separation Membrane)

SPAE having a repeating structure of a hydrophobic segment represented by the following formula (VI) and a hydrophilic segment represented by the following formula (VII) was prepared as follows. These formulae were selected among the combinations of the formulae (IV) and (V).

S-DCDPS (15.00 g), 35.47 g of 4,4′-dichlorodiphenylsulfone, 28.19 g of BP, and 23.00 g of potassium carbonate were weighed in a 1000 mL four-necked flask equipped with a cooling reflux tube. Nitrogen was flown thereinto at 0.5 L/min. NMP (259 mL) was added thereto. The flask was put in an oil bath, and heated to 150° C. The contents were stirred at 150° C. for 30 minutes. After that, temperature was raised up to 210° C., and the reaction was conducted for 12 hours. After that, the system was allowed to cool. After that, the polymerization reaction solution was precipitated into water in a strand-like form. The resulting polymer was washed with water at ordinary room temperature for 6 times, and dried in vacuo at 110° C. As a result of DS measurement, it was found that SPAE having DS of 20.0% was prepared.

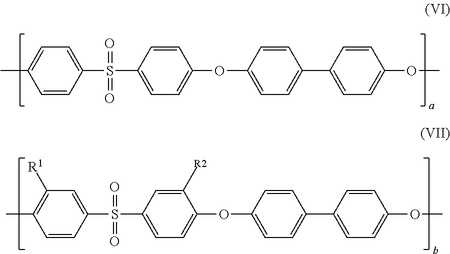

With regard to a and b as well as R¹ and R² in the above formulae, they have the same meanings as stipulated for the formulae (IV) and (V).

A glass transition temperature T_{g} of the SPAE polymer was evaluated and found to be T_{g}=265° C. As a solvent of the solvent group 2 for the SPAE polymer, no sufficient solubility therefor was noted in 2-methoxyethanol and formic acid. Although solubility in diethylene glycol was noted to some extent when stirring was conducted at about 130° C. for one night, the solution was in a gel form at ordinary room temperature whereby no good coating could be conducted. The polymer showed good solubility in NMP, DMAc, GBL, DMF and DMSO which are the solvent group 1.

Preparation of coating solution and coating method are conducted in the same way as in Example 1 whereby composite separation membrane was prepared. The resulting composite separation membrane was subjected to an NMR measurement. As a result, it was found that “a” was 4.20 ppm.

The resulting composite separation membrane was subjected to a test for evaluating the property. Permeation flow rate was 80 L/m²/day and salt rejection was 78.0% under the condition wherein the test pressure was 0.5 MPa and the sodium chloride concentration was 1500 mg/L. Permeation flow rate was 63 L/m²/day and salt rejection was 98.7% under the condition wherein the test pressure was 0.5 MPa and the magnesium sulfate concentration was 500 mg/L.

As a result of an observation under an SEM, thickness of an SPAE separation layer in the resulting composite separation membrane was 140 nm.

### Example 10

### Preparation of Porous Support Membrane

As a polymer for a porous support membrane, Polyphenylene Ether PX100L (hereinafter, abbreviated as PPE) manufactured by Mitsubishi Engineering Plastic KK was provided as in Example 1. N-Methyl-2-pyrrolidone (hereinafter, abbreviated as NMP) was added thereto so as to make PPE content 20% by mass. The resulting mixture was dissolved at 80° C. with kneading to give a homogeneous dope for membrane preparation.

After that, paper which was made from polyester (05TH-60 manufactured by Hirose Seishi) appropriately impregnated with a 50% by mass aqueous solution of glycerol was placed on a glass substrate kept at 60° C. and a dope for membrane preparation of 60° C. was uniformly coated thereon using a hand coater. After a drying treatment for about 20 seconds, it was immersed into a 35% by mass aqueous solution of NMP at 30° C. to give a porous support membrane in a flat shape. After that, a treatment of washing with water was conducted. Thickness of the PPE porous support membrane except the paper made from polyester in the resulting membrane was 40 Jim.

The PPE porous support membrane washed with water was impregnated with a 50% by mass aqueous solution of glycerol, and dried for one night at 40° C. to give a membrane subjected to a pore-filling treatment.

(Preparation of Composite Separation Membrane)

The same operation as in Example 1 was conducted whereby SPAE having DS of 15% was prepared.

A glass transition temperature T_{g} of the SPAE polymer was evaluated and found to be T_{g}=244° C. Solubility of the resulting SPAE polymer in 2-methoxyethanol, formic acid and diethylene glycol as the solvents of the solvent group 2 was tested, but no solubility was achieved. The resulting SPAE polymer could be dissolved in any of NMP, DMAc, GBL, DMF and DMSO which are the solvent group 1.

A DMSO solvent was added to the resulting SPAE. The resulting mixture was stirred at ordinary room temperature and dissolved to give a coating solution of 0.8% by mass concentration and a coating solution of 0.1% by mass concentration.

A process of making into a composite membrane was conducted by applying the above coating solution of 0.7% by mass and drying was conducted at 80° C. for 30 minutes with mild hot air. After that, a coating solution of 0.1% by mass was applied one again thereon using a brush and re-dried at 80° C. for 30 minutes whereby a composite separation membrane was prepared.

The resulting composite separation membrane was subjected to an NMR measurement. As a result, it was found that “a” was 4.20 ppm.

The resulting composite separation membrane was immersed into ethanol for 30 minutes to carry out a hydrophilizing treatment, and then subjected to a test for evaluating the property. The same operation as in other Examples was conducted using the evaluating conditions wherein the test pressure was 0.5 MPa and the sodium chloride concentration was 1500 mg/L except that an evaluating apparatus for flat sheet membrane was used. Permeation flow rate was 41 L/m²/day and salt rejection was 86.4%. Permeation flow rate was 42 L/m²/day and salt rejection was 99.6% under the condition wherein the test pressure was 0.5 MPa and the magnesium sulfate concentration was 500 mg/L.

As a result of an observation under an SEM, thickness of an SPAE separation layer in the resulting composite separation membrane was 320 nm.

### Comparative Example 1

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 5210 L/m²/day under the test pressure of 0.5 MPa.

(Preparation of Composite Separation Membrane)

The same operation as in Example 1 was conducted whereby SPAE having DS of 15.0% was prepared.

A glass transition temperature T_{g} of the SPAE polymer was evaluated and found to be T_{g}=244° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

The same operation as in Example 1 was conducted except that the drying temperature was changed to 170° C. whereby composite separation membrane was prepared. The resulting composite separation membrane was subjected to an NMR measurement. As a result, it was found that “a” was 4.13 ppm.

The resulting composite separation membrane was subjected to a test for evaluating the property. Permeation flow rate was 12 L/m²/day and salt rejection was 95.0% under the condition wherein the test pressure was 0.5 MPa and the sodium chloride concentration was 1500 mg/L. Permeation flow rate was 11 L/m²/day and salt rejection was 99.8% under the condition wherein the test pressure was 0.5 MPa and the magnesium sulfate concentration was 500 mg/L.

As a result of an observation under an SEM, thickness of an SPAE separation layer in the resulting composite separation membrane was 150 nm.

### Comparative Example 2

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 4990 L/m²/day under the test pressure of 0.5 MPa.

(Preparation of Composite Separation Membrane)

The same operation as in Example 1 was conducted whereby SPAE having DS of 15.0% was prepared.

A glass transition temperature T_{g} of the SPAE polymer was evaluated and found to be T_{g}=244° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

The same operation as in Example 1 was conducted except that the drying temperature was changed to 70° C. whereby composite separation membrane was prepared. The resulting composite separation membrane was subjected to an NMR measurement. As a result, it was found that “a” was 5.52 ppm.

The resulting composite separation membrane was subjected to a test for evaluating the property. Permeation flow rate was 3120 L/m²/day and salt rejection was 4.2% under the condition wherein the test pressure was 0.5 MPa and the sodium chloride concentration was 1500 mg/L. Permeation flow rate was 1710 L/m²/day and salt rejection was 15.0% under the condition wherein the test pressure was 0.5 MPa and the magnesium sulfate concentration was 500 mg/L.

As a result of an observation under an SEM, thickness of an SPAE separation layer in the resulting composite separation membrane was 170 nm.

### Comparative Example 3

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 5000 L/m²/day under the test pressure of 0.5 MPa.

(Preparation of Composite Separation Membrane)

The same operation as in Example 5 was conducted whereby SPAE having DS of 65.0% was prepared.

A glass transition temperature T_{g} of the SPAE polymer was evaluated and found to be T_{g}=399° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

The same operation as in Example 3 was conducted whereby composite separation membrane was prepared. The resulting composite separation membrane was subjected to an NMR measurement. As a result, it was found that “a” was 5.53 ppm.

The resulting composite separation membrane was subjected to a test for evaluating the property. Permeation flow rate was 3420 L/m²/day and salt rejection was 2.8% under the condition wherein the test pressure was 0.5 MPa and the sodium chloride concentration was 1500 mg/L. Permeation flow rate was 1920 L/m²/day and salt rejection was 10.0% under the condition wherein the test pressure was 0.5 MPa and the magnesium sulfate concentration was 500 mg/L.

As a result of an observation under an SEM, thickness of an SPAE separation layer in the resulting composite separation membrane was 140 nm.

### Comparative Example 4

### Preparation of Porous Support Membrane

As a polymer for a porous support membrane, a PPE porous support membrane was prepared by the same method as in Example 1 and subjected to a pore-filling treatment. Outer diameter and membrane thickness of the hollow fiber membrane were 260 μm and 45 μm, respectively. Permeation flow rate FR of the pure water was 8020 L/m²/day under the test pressure of 0.5 MPa.

(Preparation of Composite Separation Membrane)

S-DCDPS (6.50 g), 35.66 g of DCBN, 41.06 g of BP, and 33.53 g of potassium carbonate were weighed in a 1000 mL four-necked flask equipped with a cooling reflux tube. Nitrogen was flown thereinto at 0.5 L/min. NMP (261 mL) was added thereto. The flask was put in an oil bath, and heated to 150° C. The contents were stirred at 150° C. for 30 minutes. After that, temperature was raised up to 210° C., and the reaction was conducted for 12 hours. After that, the system was allowed to cool. After that, the polymerization reaction solution was precipitated into water in a strand-like form. The resulting polymer was washed with water at ordinary room temperature for 6 times, and dried in vacuo at 110° C. As a result of DS measurement, it was found that SPAE having DS of 6.0% was prepared.

A glass transition temperature T_{g} of the SPAE polymer was evaluated and found to be T_{g}=232° C. Solubility of the resulting SPAE polymer in 2-methoxyethanol, formic acid and diethylene glycol as the solvents of the solvent group 2 was tested, but no sufficient solubility was achieved. The resulting SPAE polymer could be dissolved in any of NMP, DMAc, GBL, DMF and DMSO which are the solvent group 1.

A composite separation membrane was prepared by the same method as in Example 1. The resulting composite separation membrane was subjected to an NMR measurement but the peak derived from water in the membrane was significantly small whereby the analysis was difficult.

The resulting composite separation membrane was subjected to a test for evaluating the property. Permeation could not be confirmed under the condition wherein the test pressure was 0.5 MPa and the sodium chloride concentration was 1500 mg/L, and under the condition wherein the test pressure was 0.5 MPa and the magnesium sulfate concentration was 500 mg/L.

As a result of an observation under an SEM, thickness of an SPAE separation layer in the resulting composite separation membrane was 150 nm.

### Comparative Example 5

### Preparation of Porous Support Membrane

Polyether Sulfone 5200P (hereinafter, abbreviated as PES) manufactured by Sumitomo Chemical Co., Ltd. as a polymer for a porous support membrane, and Polyvinylpyrrolidone K85 (hereinafter, abbreviated as PVP) manufactured by BASF SE as a hydrophilic polymer were provided. NMP was added thereto so as to make PES content 25% by mass and PVP content 2% by mass. The resulting mixture was dissolved at 80° C. with kneading to give a homogeneous dope for membrane preparation.

After that, the dope for membrane preparation was kept at the temperature of 60° C., and extruded from a double cylindrical nozzle into a shape of hollow fiber membrane. At the same time, a 70% by mass aqueous solution of NMP was extruded as an inner liquid to mold. The resulting one was made to run in air of ordinary room temperature for a drying treatment, and then immersed in a coagulation bath of 40° C. filled with a 35% by mass aqueous solution of NMP. The resulting PES porous support membrane was subjected to a washing treatment with water.

Outer diameter and membrane thickness of the resulting PES porous support membrane were 255 μm and 40 μm, respectively. As a result of pure water permeability test, permeation flow rate FR of the pure water was 5020 L/m²/day under the test pressure of 0.5 MPa.

(Preparation of Composite Separation Membrane)

The PES porous support membrane was passed through a bath filled with the SPAE coating solution in a DMSO solvent prepared by the same method as in Example 1 whereby the membrane significantly swelled and then dissolved resulting in fiber breakage. Accordingly, composite separation membrane could not be obtained.

### Comparative Example 6

### Preparation of Porous Support Membrane

Polyvinylidene Fluoride kynar301F (hereinafter, abbreviated as PVDF) manufactured by Arkema S.A. as a polymer for a porous support membrane, and Polyvinylpyrrolidone K85 (hereinafter, abbreviated as PVP) manufactured by BASF SE as a hydrophilic polymer were provided. NMP was added thereto so as to make PVDF content 25% by mass and PVP content 2% by mass. The resulting mixture was dissolved at 150° C. with kneading to give a homogeneous dope for membrane preparation.

After that, the dope for membrane preparation was kept at the temperature of 60° C., and extruded from a double cylindrical nozzle into a shape of hollow fiber membrane. At the same time, a 70% by mass aqueous solution of NMP was extruded as an inner liquid to mold. The resulting one was made to run in air of ordinary room temperature for a drying treatment, and then immersed in a coagulation bath of 40° C. filled with a 35% by mass aqueous solution of NMP. The resulting PVDF porous support membrane was subjected to a washing treatment with water.

Outer diameter and membrane thickness of the resulting PVDF porous support membrane were 260 μm and 50 μm, respectively. As a result of pure water permeability test, permeation flow rate FR of the pure water was 4280 L/m²/day under the test pressure of 0.5 MPa.

(Preparation of Composite Separation Membrane)

The PVDF porous support membrane was passed through bath filled with the SPAE coating solution in a DMSO solvent prepared by the same method as in Example 1 whereby, the same as in the case of the PES membrane of Comparative Example 1, the membrane swelled and the fiber dissolved in a drying furnace of 80° C. resulting in fiber breakage. Accordingly, composite separation membrane could not be obtained.

### Comparative Example 7

### Preparation of a Coating Solution

To an SPAE having sulfonation degree DS of 15.0% prepared by the same method as in Example 1 was added each of 2-methoxyethanol, formic acid and diethylene glycol from the solvent group 2 so as to make the SPAE content 3% by mass followed by stirring at 100° C. However, dissolved state was not resulted, and composite separation membrane could not be obtained.

TABLE 2

| | | | Example 1 | Example 2 | Example 3 | Example 4 | Example 5 | Example 6 |
|---|---|---|---|---|---|---|---|---|
| Porous support membrane | | | PPE | PPE | PPE | PPE | PPE | PPE |
| Membrane shape | | | hollow fiber | hollow fiber | hollow fiber | hollow fiber | hollow fiber | hollow fiber |
| | | | membrane | membrane | membrane | membrane | membrane | membrane |
| SPAE chemical structure | | | formula | formula | formula | formula | formula | formula |
| | | | (I)(II) | (I)(II) | (I)(II) | (I)(II) | (I)(II) | (I)(II) |
| Coating solvent | | | DMSO | DMSO | DMSO | DMSO | DMSO | GBL |
| Drying temperature | | ° C. | 115 | 80 | 110 | 175 | 175 | 115 |
| Degree of sulfonation DS | | % | 15.0 | 15.0 | 44.0 | 44.0 | 65.0 | 15.0 |
| Ion exchange capacity IEC | | meq/g | 0.92 | 0.92 | 2.17 | 2.17 | 2.80 | 0.92 |
| Glass transition temperature T_{g} | | ° C. | 244 | 244 | 322 | 322 | 399 | 244 |
| Thickness of support layer | | μm | 45 | 45 | 45 | 45 | 45 | 45 |
| Outer diameter of support layer | | μm | 260 | 260 | 260 | 260 | 260 | 260 |
| Thickness of separation layer | | nm | 160 | 140 | 150 | 140 | 160 | 160 |
| −10° C. chemical shift | | ppm | 4.19 | 4.72 | 4.92 | 4.55 | 4.68 | 4.18 |
| 1500 ppm | water permeation | L/m²/D | 42 | 750 | 1200 | 400 | 700 | 58 |
| NaCl evaluation | property | | | | | | | |
| | rejection | % | 84.0 | 35.0 | 25.0 | 60.2 | 38.4 | 82.5 |
| 500 ppm | water permeation | L/m²/D | 45 | 155 | 240 | 120 | 105 | 55 |
| MgSO₄ evaluation | property | | | | | | | |
| | rejection | % | 99.6 | 78.2 | 71.8 | 91.2 | 78.8 | 99.5 |
| | | | | | | | Comparative | Comparative |
| | | | Example 7 | Example 8 | Example 9 | Example 10 | Example 1 | Example 2 |
| Porous support membrane | | | PPE | PPE | PPE | PPE | PPE | PPE |
| Membrane shape | | | hollow fiber | hollow fiber | hollow fiber | flat sheet | hollow fiber | hollow fiber |
| | | | membrane | membrane | membrane | membrane | membrane | membrane |
| SPAE chemical structure | | | formula | formula | formula | formula | formula | formula |
| | | | (I)(II) | (I)(II) | (VI)(VII) | (I)(II) | (I)(II) | (I)(II) |
| Coating solvent | | | NMP/DMSO | DEG/DMSO | DMSO | DMSO | DMSO | DMSO |
| Drying temperature | | ° C. | 115 | 115 | 115 | 115 | 170 | 70 |
| Degree of sulfonation DS | | % | 15.0 | 15.0 | 20.0 | 15.0 | 15.0 | 15.0 |
| Ion exchange capacity IEC | | meq/g | 0.92 | 0.92 | 0.92 | 0.92 | 0.92 | 0.92 |
| Glass transition temperature T_{g} | | ° C. | 244 | 244 | 265 | 244 | 244 | 244 |
| Thickness of support layer | | μm | 45 | 45 | 45 | 40 | 45 | 45 |
| Outer diameter of support layer | | μm | 260 | 260 | 260 | none | 260 | 260 |
| Thickness of separation layer | | nm | 150 | 180 | 140 | 320 | 150 | 170 |
| −10° C. chemical shift | | ppm | 4.20 | 4.18 | 4.20 | 4.20 | 4.13 | 5.52 |
| 1500 ppm | water permeation | L/m²/D | 46 | 59 | 80 | 41 | 12 | 3120 |
| NaCl evaluation | property | | | | | | | |
| | rejection | % | 84.0 | 81.5 | 78.0 | 86.4 | 95.0 | 4.2 |
| 500 ppm | water permeation | L/m²/D | 43 | 57 | 63 | 42 | 11 | 1710 |
| MgSO₄ evaluation | property | | | | | | | |
| | rejection | % | 99.6 | 99.5 | 98.7 | 99.6 | 99.8 | 15.0 |

| | | | Comparative | Comparative | Comparative | Comparative | Comparative |
|---|---|---|---|---|---|---|---|
| | | | Example 3 | Example 4 | Example 5 | Example 6 | Example 7 |
| Porous support membrane | | | PPE | PPE | PES | PVDF | PPE |
| Membrane shape | | | hollow fiber | hollow fiber | hollow fiber | hollow fiber | hollow fiber |
| | | | membrane | membrane | membrane | membrane | membrane |
| SPAE chemical structure | | | formula | formula | formula | formula | formula |
| | | | (I)(II) | (I)(II) | (I)(II) | (I)(II) | (I)(II) |
| Coating solvent | | | DMSO | DMSO | DMSO | DMSO | 2-methoxyethanol |
| | | | | | | | diethylene glycol |
| | | | | | | | formic acid |
| Drying temperature | | ° C. | 110 | 115 | fiber breakage | fiber breakage | no dissolution |
| Degree of sulfonation DS | | % | 65.0 | 6.0 | — | — | — |
| Ion exchange capacity IEC | | meq/g | 2.80 | 0.40 | — | — | — |
| Glass transition temperature T_{g} | | ° C. | 399 | 232 | — | — | — |
| Thickness of support layer | | μm | 45 | 45 | — | — | — |
| Outer diameter of support layer | | μm | 260 | 260 | — | — | — |
| Thickness of separation layer | | nm | 140 | 150 | — | — | — |
| −10° C. chemical shift | | ppm | 5.53 | no peak could | — | — | — |
| | | | | be confirmed | | | |
| 1500 ppm | water permeation | L/m²/D | 3420 | no permeation | — | — | — |
| NaCl evaluation | property | | | | | | |
| | rejection | % | 2.8 | | — | — | — |
| 500 ppm | water permeation | L/m²/D | 1920 | no permeation | — | — | — |
| MgSO₄ evaluation | property | | | | | | |
| | rejection | % | 10.0 | | — | — | — |

### INDUSTRIAL APPLICABILITY

The composite separation membrane of the present invention can control its salt rejection property and water permeation property in high levels in spite of the use of a material excellent in resistance to chemicals. Accordingly, it is very useful in a liquid treatment membrane for nanofiltration.

### EXPLANATION OF REFERENCE NUMBER

1: Separation layer formed of SPAE
2: Porous support membrane formed of PPE
3: Nonwoven fabric

1. A composite separation membrane comprising a porous support membrane and a thin film of a sulfonated polyarylene ether copolymer, characterized in that
(a) the porous support membrane is mainly formed of polyphenylene ether and
(b) when proton nuclear magnetic resonance spectrum is measured at −10° C. using the composite separation membrane being moistened under a condition of constant temperature and constant humidity, a peak top position derived from water contained in the membrane is from 4.15 ppm to less than 5.00 ppm provided that a peak top position of tetramethylsilane which is an internal standard substance is taken as 0 ppm.

2. The composite separation membrane according to claim 1, wherein said sulfonated polyarylene ether copolymer is constituted from a repeating structure of a hydrophobic segment represented by the following formula (IV) and a hydrophilic segment represented by the following formula (V): 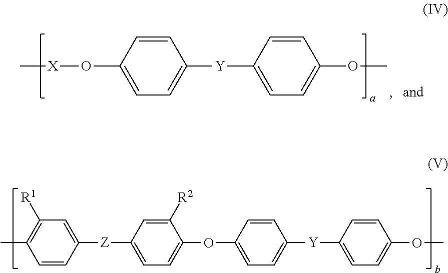
wherein X is either the following formula (VIII) or (IX): 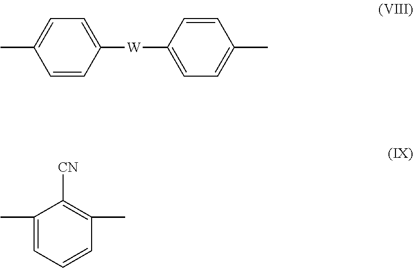
wherein Y is a single bond or any of the following formulae (X)-(XIII): 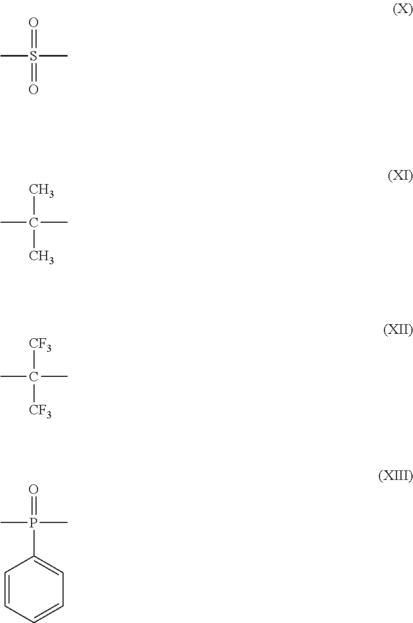
wherein Z is a single bond or any of the following formulae (X), (XIV) and (XIII): 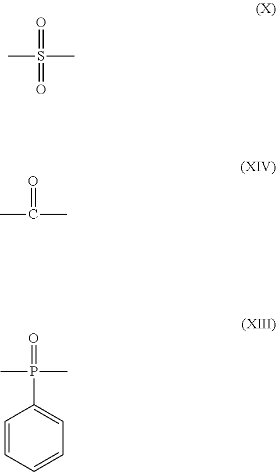
wherein W is a single bond or any of the following formulae (X), (XIV) and (XIII): 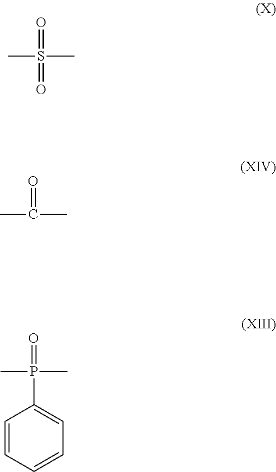
wherein Y and W are not selected as the same thing;
wherein a and b each represents a natural number of 1 or more;
wherein R¹ and R² each represents —SO₃M or —SO₃H, wherein M represents a metal element; and
wherein a sulfonation rate in terms of a percent rate of repeating number of the formula (V) in the sulfonated polyarylene ether copolymer to total of repeating number of the formula (IV) and repeating number of the formula (V) in the sulfonated polyarylene ether copolymer is more than 10% and less than 70%.

3. The composite separation membrane according to claim 1, wherein said sulfonated polyarylene ether copolymer is constituted from a repeating structure of a hydrophobic segment represented by the following formula (I) and a hydrophilic segment represented by the following formula (II): 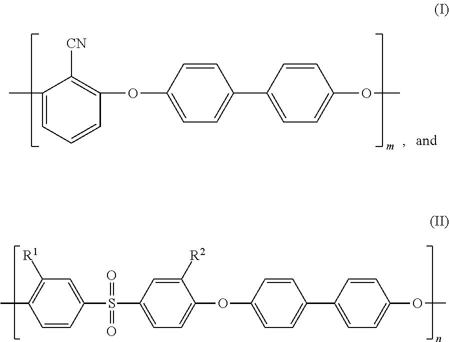
wherein m and n each represents a natural number of 1 or more;
wherein R¹ and R² each represents —SO₃M or —SO₃H, wherein M represents a metal element; and
wherein a sulfonation rate in terms of a percent rate of repeating number of the formula (II) in the sulfonated polyarylene ether copolymer to total of repeating number of the formula (I) and repeating number of the formula (II) in the sulfonated polyarylene ether copolymer is more than 10% and less than 70%.

4. The composite separation membrane according to claim 1, wherein thickness of the thin film of the sulfonated polyarylene ether copolymer is from 50 nm to 500 nm.

5. The composite separation membrane according to claim 1, wherein the composite separation membrane is for a nanofiltration membrane.

6. The composite separation membrane according to claim 1, wherein the composite separation membrane is a hollow fiber membrane.
